(19) United States
(12) Patent Application Publication
(10) Pub. No.: US 2004/0151352 A1
(43) Pub. Date: Aug. 5, 2004

(54) Pattern collation apparatus

(76) Inventors: Hiroshi Nakajima, Tokyo (JP); Koji Kobayashi, Tokyo (JP)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/719,410

(22) Filed: Nov. 21, 2003

(30) Foreign Application Priority Data
Nov. 25, 2002 (JP) 340515/2002

(51) Int. Cl. G06K 9/00

(52) U.S. Cl. 382/124

(57) ABSTRACT

In a pattern collation apparatus which collates a registration pattern with a collation pattern, a first collation section executes collation between the registration pattern and the collation pattern on the basis of the correlation value between the patterns. A second collation section executes collation between the registration pattern and the collation pattern on the basis of a feature parameter defined in advance. A collation determination section determines that the registration pattern coincides with the collation pattern by using at least one of the collation results by the first and second collation sections.

### BACKGROUND OF THE INVENTION

The present invention relates to a pattern collation apparatus which collates a registration pattern with a collation pattern.

There is conventionally a pattern collation apparatus which employs a collation algorithm called a correlation method based on cross correlation between a registration pattern and a collation pattern.

This pattern collation apparatus executes two-dimensional discrete Fourier transform for a two-dimensional collation pattern to create collation Fourier pattern data. The collation Fourier pattern data is synthesized with the registration Fourier pattern data of a registration pattern, which is created by the same processing as that for the collation Fourier pattern data. Two-dimensional discrete Fourier transform (or two-dimensional discrete inverse Fourier transform) is executed for the synthesized Fourier pattern data. The coincidence/incoincidence between the collation pattern and the registration pattern is determined on the basis of a correlation value obtained from the synthesized pattern data (correlation pattern data) that has undergone two-dimensional discrete Fourier transform (or two-dimensional discrete inverse Fourier transform).

The present applicant has proposed before a pattern collation apparatus which collates N-dimensional patters [e.g., voiceprints (one-dimensional), fingerprints (two-dimensional), and stereoscopic patterns (three-dimensional)] on the basis of frequency characteristics or spatial frequency characteristics (Japanese Patent Laid-Open No. 9-22406 (reference 1)).

In reference 1, a kind of amplitude suppression processing (e.g., log processing) is executed for a synthesized Fourier pattern in a spatial frequency space. In addition, mention is made of a “phase only correlation method” in which a collation result is obtained by calculating the correlation value between a registration pattern and a collation pattern on the basis of only the phase components of Fourier pattern data that is obtained by executing Fourier transform for the registration and collation patterns.

In addition to the above-described correlation method, a scheme called a feature point method is also used. In this feature point method, the feature points (e.g., an end point at an end of a fingerprint pattern, a branch point at a branch of the pattern, or a corner of a graphic pattern) of two patterns to be collated are extracted. The coincidence/incoincidence between the collation pattern and the registration pattern is determined on the basis of feature parameters that represent the microscopic feature point information (e.g., the positions, directions, and types of the feature points) (Japanese Patent Laid-Open No. 7-57084 (reference 2) and Japanese Patent Laid-Open No. 1-211184 (reference 3)).

The correlation method and, particularly, the amplitude suppression correlation method including the above-described phase only correlation method is resistant against the influence of changes in environment such as illuminance in inputting a collation pattern to the collation apparatus or the influence of the positional shift between a registration pattern and a collation pattern and has a very high collation accuracy, as compared to the feature point method that is used as a general collation algorithm.

For example, when the amplitude suppression correlation method is used for fingerprint collation, accurate collation can be done even if the image quality of a registration fingerprint or collation fingerprint is poor due to a dry or wet finger or chappy skin. FIGS. 30A and 30B show the images of registration and collation fingerprints of a person who has chappy skin and therefore exhibits distorted patterns. Even in this case, since the amplitude suppression correlation method executes collation on the basis of spatial frequency characteristics, the coincidence/incoincidence between the two fingerprints can be determined. In the feature point method, however, since no end point or branch point can be extracted, it is difficult to determine the coincidence/incoincidence between the two fingerprints.

However, recent experiments indicate that patterns of a certain type can correctly be collated by the feature point method but not by the amplitude suppression correlation method. For example, assume that a registration fingerprint is properly obtained, as shown in FIG. 31A, and a collation fingerprint is obtained at only the fingertip, as shown in FIG. 31B. In the fingerprint of only the fingertip, the pattern is distorted. For this reason, the amplitude suppression correlation method may be unable to determine the coincidence/incoincidence between the two fingerprints. To the contrary, the feature point method can extract an end point or branch point even from the fingerprint of only the fingertip. Hence, the coincidence/incoincidence between two fingerprints can be determined.

### SUMMARY OF THE INVENTION

It is an object of the present invention to provide a pattern collation apparatus which combines collation methods of different types, i.e., the correlation method and the feature point method to compensate for their disadvantages and obtains a much higher collation accuracy than an apparatus which executes a single method.

In order to achieve the above object, according to the present invention, there is provided a pattern collation apparatus for collating a registration pattern with a collation pattern, comprising first collation means for executing collation between the registration pattern and the collation pattern on the basis of a correlation value between the patterns, second collation means for executing collation between the registration pattern and the collation pattern on the basis of a feature parameter defined in advance, and collation determination means for determining that the registration pattern coincides with the collation pattern by using at least one of a collation result by the first collation means and a collation result by the second collation means.

### BRIEF DESCRIPTION OF THE DRAWINGS

FIG. 1 is a block diagram of a fingerprint collation apparatus according to an embodiment of the present invention;

FIG. 2 is a flow chart for explaining a fingerprint registration operation in the fingerprint collation apparatus;

FIG. 3 is a flow chart showing processing for calculating the area and image quality value of a registration fingerprint in the flow chart shown in FIG. 2;

FIGS. 4A and 4B are views showing photos on a display, which indicate fingerprint images and ridge-direction block images obtained from the fingerprint images;

FIG. 5 is a flow chart for explaining a fingerprint collation operation (collection method (1)) of the fingerprint collation apparatus;

FIGS. 6A to 6H are views showing photos on a display so as to explain the fingerprint collation process of the fingerprint collation apparatus;

FIG. 7 is a graph showing the ROC curves of the amplitude suppression correlation method (characteristic I), the feature point method (characteristic II), and a combined method of the amplitude suppression correlation method and feature point method (characteristic III: a method of the present invention);

FIG. 8 is a bar graph showing the EERs of the methods, which are obtained from the ROC curves;

FIG. 9 is a functional block diagram corresponding to collation processing (collation method (1)) executed in accordance with the flow chart shown in FIG. 5;

FIG. 10 is a flow chart for explaining another fingerprint collation operation (collection method (2)) of the fingerprint collation apparatus;

FIG. 11 is a functional block diagram corresponding to collation processing (collation method (2)) executed in accordance with the flow chart shown in FIG. 10;

FIG. 12 is a flow chart for explaining still another fingerprint collation operation (collection method (3)) of the fingerprint collation apparatus;

FIG. 13 is a functional block diagram corresponding to collation processing (collation method (3)) executed in accordance with the flow chart shown in FIG. 12;

FIG. 14 is a functional block diagram that employs a collation method (4);

FIG. 15 is a flow chart for explaining still another fingerprint collation operation (collection method (5)) of the fingerprint collation apparatus;

FIG. 16 is a functional block diagram corresponding to collation processing (collation method (5)) executed in accordance with the flow chart shown in FIG. 15;

FIG. 17 is a flow chart of processing in which processing necessary for collation by the correlation method and processing necessary for collation by the feature point method are executed for the original image data of a registration fingerprint at the time of registration to prepare registration data for the correlation method and registration data for the feature point method and obtain their scores;

FIG. 18 is a flow chart for explaining a fingerprint registration operation according to the second embodiment;

FIGS. 19A and 19B are views for explaining transformation from a Cartesian coordinate system to a polar coordinate system;

FIG. 20 is a flow chart for explaining a fingerprint collation operation according to the second embodiment;

FIGS. 21A to 21G are views for explaining a coarse collation process according to the second embodiment;

FIG. 22 is a flow chart showing processing contents (first collation) in step S711 shown in FIG. 20;

FIG. 23 is a flow chart showing processing contents (second collation) in step S712 shown in FIG. 20;

FIGS. 24A to 24H are views showing photos on a display, which indicate images so as to explain processing after polar coordinate transformation in the coarse collation process (first collation);

FIGS. 25A to 25H are views showing photos on a display, which indicate images so as to explain a fine collation process (second collation) according to the second embodiment;

FIG. 26 is a flow chart for explaining a collation (third collation) operation by the feature point method according to the second embodiment;

FIG. 27 is a flow chart for explaining a fingerprint collation operation according to the third embodiment;

FIG. 28 is a flow chart for explaining a fingerprint collation operation according to the fourth embodiment;

FIGS. 29A to 29G are views showing photos on a display, which indicate images so as to explain a coarse collation (first collation) process according to the fourth embodiment;

FIGS. 30A and 30B are views showing photos on a display, which indicate the images of registration and collation fingerprints of a person who has chappy skin with distorted patterns; and

FIGS. 31A and 31B are views showing photos on a display, which indicate the images of registration and collation fingerprints which can correctly be collated by the feature point method but not by the amplitude suppression correlation method.

### DESCRIPTION OF THE PREFERRED EMBODIMENTS

The present invention will be described below in detail with reference to the accompanying drawings.

[First Embodiment]

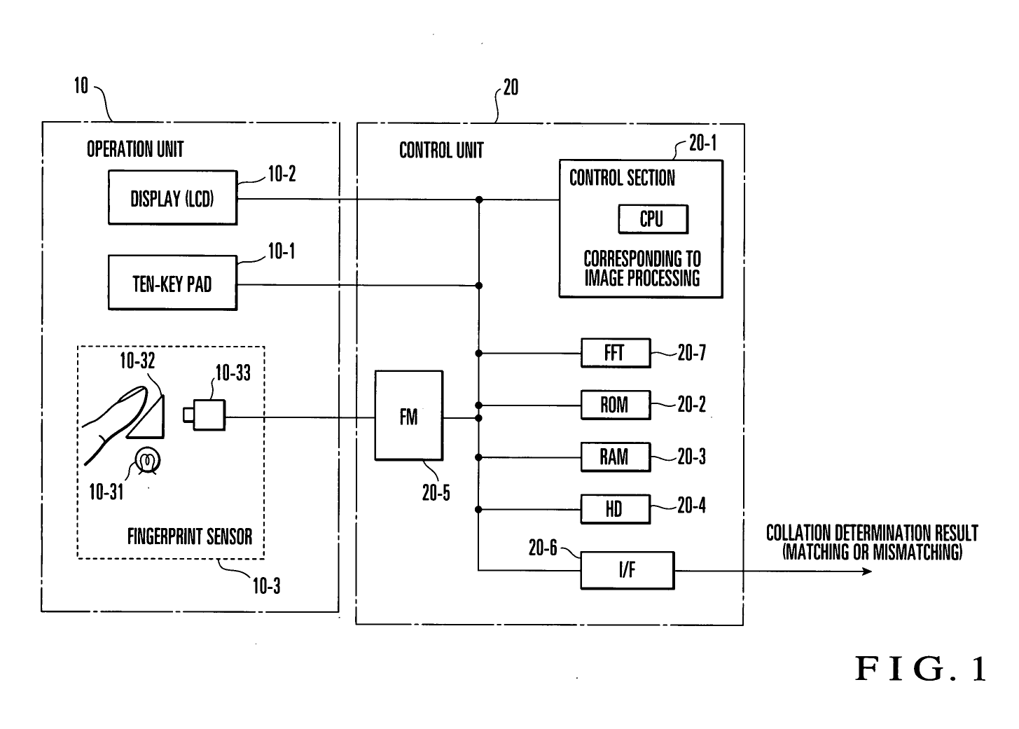

FIG. 1 shows a fingerprint collation apparatus according to an embodiment of the present invention. Referring to FIG. 1, reference numeral 10 denotes an operation unit; and 20, a control unit. The operation unit 10 has a ten-key pad 10-1, display (LCD) 10-2, and fingerprint sensor 10-3. The fingerprint sensor 10-3 has a light source 10-31, prism 10-32, and CCD camera 10-33. The control unit 20 comprises a control section 20-1 with a CPU, ROM 20-2, RAM 20-3, hard disk (HD) 20-4, frame memory (FM) 20-5, external connection section (I/F) 20-6, and Fourier transform section (FFT) 20-7. The ROM 20-2 stores a registration program and a collation program.

[Fingerprint Registration]

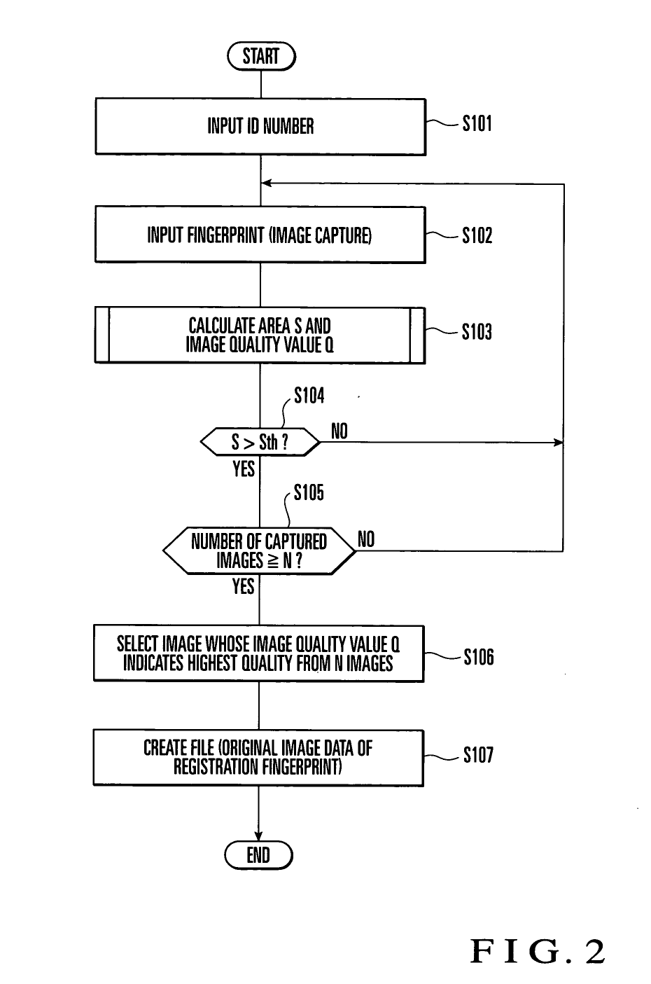

In this fingerprint collation apparatus, a user's fingerprint (to be referred to as a registration fingerprint hereinafter) to be used as a registration pattern is registered in the following way. Before the operation, the user inputs the ID number assigned to him/her by using the ten-key pad 10-1 (step S101 in FIG. 2) and places a finger on the prism 10-32 of the fingerprint sensor 10-3. The prism 10-32 is irradiated with light from the light source 10-31. The light from the light source 10-31 is totally reflected by recess portions (valley portions) of the skin surface, which do not come into contact with the surface of the prism 10-32, and arrives at the CCD camera 10-33. Inversely, the total reflection condition is not satisfied at the projecting portions (ridge portions) of the skin surface, which come into contact with the surface of the prism 10-32, so that the light from the light source 10-31 scatters. For these reasons, a pattern with contrast, i.e., a fingerprint pattern having bright valley portions and dark ridge portions is sampled. The pattern of the sampled fingerprint (registration fingerprint) is A/D-converted into a halftone image (image data: two-dimensional pattern data) having, e.g., 512×512 pixels and 256 gray levels and supplied to the control unit 20.

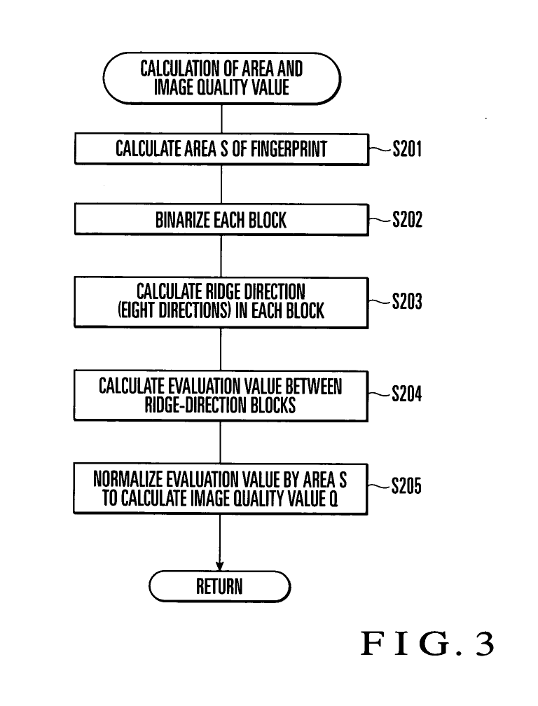

The control section 20-1 causes the frame memory 20-5 to capture the image data of the registration fingerprint supplied from the operation unit 10 (step S102) and calculates an area S and image quality value Q of the captured registration fingerprint (step S103). The calculation processing of the area S and image quality value Q is executed in accordance with the flow chart shown in FIG. 3.

The control section 20-1 extracts the boundary between a region where the fingerprint pattern is present and a region where no pattern is present from the captured registration fingerprint and calculates the number of pixels of the registration fingerprint, including the boundary, as the area S (step S201). In addition, the image of the registration fingerprint having 512×512 pixels is segmented into blocks each having 8×8 pixels. The blocks are binarized (step S202) to calculate the ridge direction (eight directions) in each block (step S203). The continuity of the ridge directions between the blocks is evaluated to obtain an evaluation value (step S204). The evaluation value is normalized by the area S to obtain the image quality value Q (step S205). The image quality value Q takes a value ranging from 0 to 1. The larger the image quality value Q is, the poorer the image quality is.

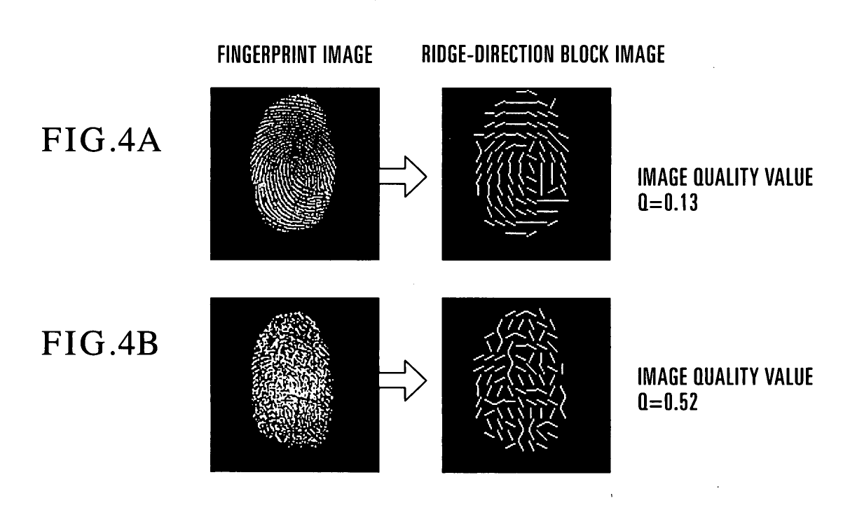

FIGS. 4A and 4B show fingerprint images and ridge-direction block images obtained from the fingerprint images. FIG. 4A shows a fingerprint image and a ridge-direction block image when the image quality value Q is 0.13. FIG. 4B shows a fingerprint image and a ridge-direction block image when the image quality value Q is 0.52. FIG. 4B shows a fingerprint image of a person who has chappy skin with distorted patterns. Since the continuity of ridge directions is poor, the image quality value becomes large.

The control section 20-1 thus calculates the area S and image quality value Q of the captured registration fingerprint and then compares the calculated area S with a predetermined threshold value Sth (step S104). When S≦Sth, the control section 20-1 determines that the area of the fingerprint is small. The flow returns to step S102 to capture the image of the registration fingerprint again. Then, the processing from step S103 is repeated. When S>Sth, the control section 20-1 determines that the area of the fingerprint is sufficiently large. The flow advances to step S105.

In step S105, the number of captured images is checked. The operation from step S102 is repeated until the number of captured images reaches N. In this way, the control section 20-1 collects N registration fingerprint images whose area S exceeds Sth (YES in step S105) and selects an image whose image quality value Q indicates the highest quality from the N registration fingerprint images (step S106). A file of the selected registration fingerprint image data is created in the hard disk 20-4 as original image data to be used as a registration pattern in correspondence with the ID number (step S107).

[Fingerprint Collation: Collation Method (1) (Correlation Method (Amplitude Suppression Correlation Method)+Feature Point Method)]

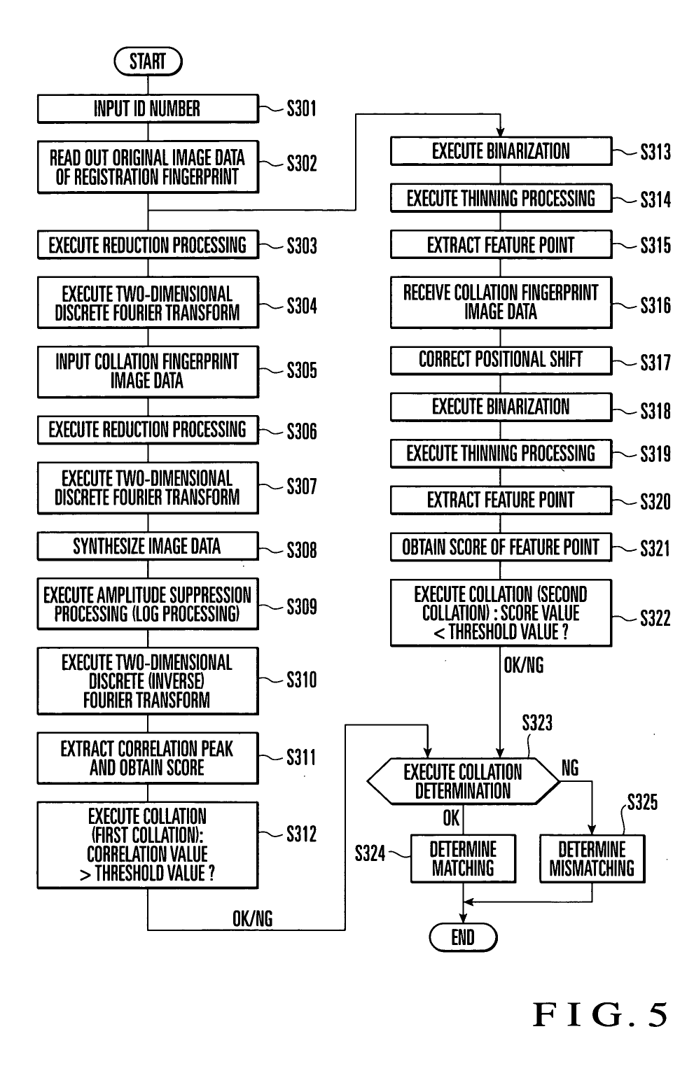

This fingerprint collation apparatus collates a user's fingerprint in the following way. During the operation, the user inputs the ID number assigned to him/her by using the ten-key pad 10-1 (step S301 in FIG. 5) and places a finger on the prism 10-32 of the fingerprint sensor 10-3. The pattern of a fingerprint (collation fingerprint) to be used as a collation pattern is sampled, as in fingerprint registration. The pattern is converted into a halftone image (image data: two-dimensional pattern data) having 512×512 pixels and 256 gray levels and supplied to the control unit 20.

[Correlation Method (Amplitude Suppression Correlation Method)]

Upon receiving the ID number through the ten-key pad 10-1, the control section 20-1 reads out the original image data of a registration fingerprint corresponding to the ID number from the files of registration fingerprint image data in the hard disk 20-4 (step S302). Reduction processing is executed for the readout original image data of the registration fingerprint (step S303). The reduction processing is done by thinning out the pixel lines of the original image data having 512×512 pixels and 256 gray levels at a predetermined pixel pitch in the x direction (horizontal direction) and y direction (vertical direction). For example, pixel lines are thinned out every four pixels in the x and y directions to obtain reduced data having 128×128 pixels.

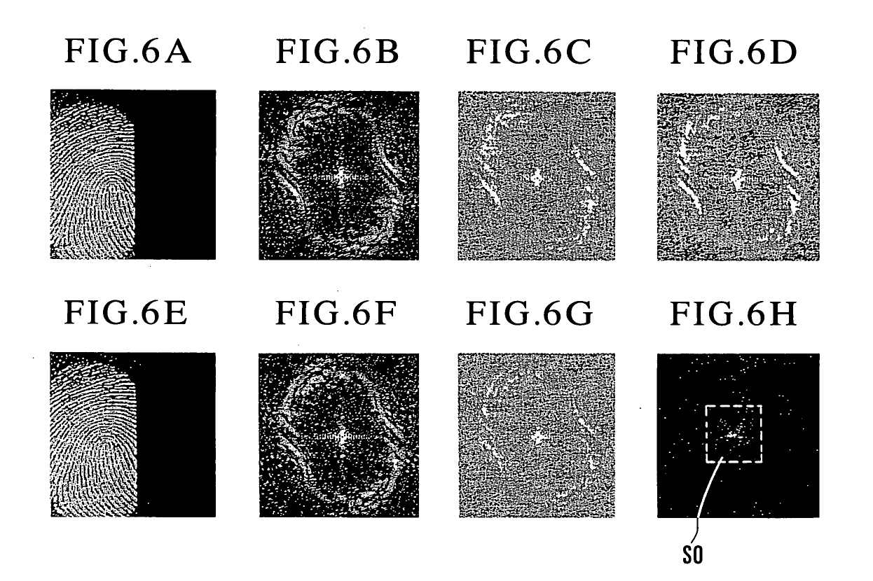

The control section 20-1 sends the reduced registration fingerprint image data (FIG. 6A) to the Fourier transform section 20-7. The registration fingerprint image data is subjected to two-dimensional discrete Fourier transform (DFT) (step S304). With this processing, the registration fingerprint image data shown in FIG. 6A changes to Fourier image data (registration Fourier image data) shown in FIG. 6B.

The control section 20-1 also receives the collation fingerprint image data supplied from the operation unit 10 through the frame memory 20-5 (step S305). The received collation fingerprint image data is also subjected to the same reduction processing as in step S303 (step S306).

The control section 20-1 sends the reduced collation fingerprint image data (FIG. 6E) to the Fourier transform section 20-7. The collation fingerprint image data is subjected to two-dimensional discrete Fourier transform (DFT) (step S307). With this processing, the collation fingerprint image data shown in FIG. 6E changes to Fourier image data (collation Fourier image data) shown in FIG. 6F.

Note that the two-dimensional discrete Fourier transform is described in “Introduction to Computer Image Processing”, edited by Nihon Kogyo Gijutsu Center, published by Souken Shuppan, pp. 44-45 (reference 4).

Next, the control section 20-1 synthesizes the Fourier image data of the collation fingerprint obtained in step S307 and the Fourier image data of the registration fingerprint obtained in step S304 (step S308) to obtain synthesized Fourier image data.

Let A·exp(jθ) be the Fourier image data of the collation fingerprint, and B·exp(jφ) be the Fourier image data of the registration fingerprint. The synthesized Fourier image data is given by A·B·exp(j(θ−φ)) that is obtained by multiplying the Fourier image data of the collation fingerprint by the complex conjugate of the Fourier image data of the registration fingerprint, where A, B, θ, and φ are functions of the spatial frequency (Fourier) space (u,v).

A·B·exp(jθ−φ)) can be written to

$$A \cdot B \cdot exp ( j ( θ - φ ) ) = A \cdot B \cdot cos ( θ - φ ) + j \cdot A \cdot B \cdot sin ( θ - φ ) \qquad ( 1 )$$

When A·exp(jθ)=α₁+jβ₁ and B·exp(jφ)=α₂+jβ₂, A=(α₁²+β₁²)^{1/2}, B=(α₂²+β₂²)^{1/2}, θ=tan⁻¹(β₁/α₁) and φ=tan⁻¹(β₂/α₂). The synthesized Fourier image data is obtained by calculating equation (1).

Note that the synthesized Fourier image data may be obtained by calculating A·B·exp(j(θ−φ))=A·B·exp(jθ)·exp(−jφ)=A·exp(jθ)·B·exp(−jφ)=(α₁+jβ₁)·(α₂−jβ₂)=(α₁·α₂+β₁·β₂)+j(α₂·β₁=α₁·β₂).

After obtaining the synthesized Fourier image data, the control section 20-1 executes amplitude suppression processing (step S309). In this embodiment, log processing is executed as amplitude suppression processing. More specifically, the log of the amplitude A·B in A·B·exp(j(θ−φ)) described above, i.e., the arithmetic expression of the synthesized Fourier image data, is calculated as log(A·B)·exp(j(θ−φ)), thereby suppressing the amplitude A·B to log(A·B) (A·B<log(A·B)).

FIG. 6D shows the synthesized Fourier image data after the amplitude suppression processing. In the synthesized Fourier image data that has undergone the amplitude suppression processing, the influence of the illuminance difference between the registration fingerprint sampling time and the collation fingerprint sampling time is small. More specifically, when the amplitude suppression processing is executed, the spectrum intensity of each pixel is suppressed. Since any extreme value can be eliminated, the valid information amount increases. In addition, when the amplitude suppression processing is executed, of the fingerprint information, the feature points (end points and branch points) or the features (vortexes and branches) of ridge portions as personal information in the fingerprint information are emphasized. Hence, the flow and direction of all the ridge portions as general fingerprint information are suppressed.

In this embodiment, log processing is executed as amplitude suppression processing. Alternatively, root processing may be executed. The present invention is not limited to log processing or root processing. Any other processing that can suppress the amplitude can be executed. When all amplitudes are suppressed to, e.g., 1 by amplitude suppression, i.e., only phases are obtained, the calculation amount and data amount become smaller than in log processing or root processing.

After the amplitude suppression processing is executed in step S309, the synthesized Fourier image data that has undergone the amplitude suppression processing is sent to the Fourier transform section 20-7 to execute two-dimensional discrete Fourier transform (DFT) again (step S310). With this processing, the synthesized Fourier image data shown in FIG. 6D changes to synthesized image data shown in FIG. 6H. This image can basically be regarded as an image with convolutions of the collation fingerprint and registration fingerprint although the amplitude in the frequency space is suppressed. The synthesized image data represents the correlation between the two images.

The control section 20-1 receives the synthesized image data obtained in step S310. The intensity (amplitude) of each pixel in a predetermined correlation component area is scanned from the synthesized image data to obtain the histogram of the intensities of the correlation components of the pixels in the collation fingerprint and registration fingerprint. Upper n pixels (eight pixels in this embodiment) which have high correlation component intensities are extracted from the histogram. The average of the intensities (correlation peaks) of the correlation components of the n extracted pixels is obtained as a correlation value (score) (step S311). The correlation component area is defined as an area SO indicated by a white dot line in the synthesized Fourier image data shown in FIG. 6H.

The control section 20-1 compares the correlation value obtained in step S311 with a predetermined threshold value (step S312). If the correlation value is larger than the threshold value, it is determined that the collation result by the amplitude suppression correlation method indicates “coincidence (OK)”. If the correlation value is equal to or smaller than the threshold value, it is determined that the collation result by the amplitude suppression correlation method indicates “incoincidence (NG)”.

[Feature Point Method]

On the other hand, the control section 20-1 binarizes the original image data of the registration fingerprint read out in step S302 (step S313) and executes thinning processing for the binarized registration fingerprint image data (step S314). Feature points (end points and branch points) are extracted from the registration fingerprint image data that has undergone the thinning processing, and the positions, directions, and types of the feature points are acquired as feature parameters (step S315).

In addition, the control section 20-1 receives the collation fingerprint image data supplied from the operation unit 10 through the frame memory 20-5 (step S316) and corrects the positional shift between the collation fingerprint image data and the registration fingerprint image data (step S317). The same binarization processing and thinning processing as in steps S313 and S314 are executed for the received collation fingerprint image data (steps S318 and S319). Feature points (end points and branch points) are extracted from the collation fingerprint image data that has undergone the binarization processing and thinning processing, and the positions, directions, and types of the feature points are acquired as feature parameters (step S320).

The control section 20-1 obtains the error values (for example, if a feature point that should be an end point is a branch point, the error value is defined as 10) of the feature point parameters such as the positions, directions, and types of the feature points of the registration fingerprint and collation fingerprint, which are extracted in steps S315 and S320. The error values are added to obtain a collation score (step S321). The resultant collation score is compared with a predetermined threshold value (step S322). If the collation score is smaller than the threshold value, it is determined that the collation result by the feature point method indicates “coincidence (OK)”. If the collation score is equal to or larger than the threshold value, it is determined that the collation result by the feature point method indicates “incoincidence (NG)”.

[ORing Collation Result by Correlation Method (Amplitude Suppression Correlation Method) and Collation Result by Feature Point Method]

The control section 20-1 executes final collation determination on the basis of the collation result obtained in step S312 by the amplitude suppression correlation method and the collation result obtained in step S322 by the feature point method (step S323). In this case, if it is determined that the collation result by one of the methods indicates “coincidence (OK)”, the control section 20-1 determines that the registration fingerprint and collation fingerprint “coincide (match)” (step S324). To the contrary, if it is determined that the collation results by both methods indicate “incoincidence (NG)”, the control section 20-1 determines that the registration fingerprint and collation fingerprint “do not coincide (mismatch)” (step S325).

More specifically, in the collation method (1), when the coincidence is determined not by the amplitude suppression correlation method but by the feature point method, it is determined that the registration fingerprint and collation fingerprint coincide. When the coincidence is determined not by the feature point method but by the amplitude suppression correlation method, it is determined that the registration fingerprint and collation fingerprint coincide. When the coincidence is not determined by either the amplitude suppression correlation method or the feature point method, it is determined that the registration fingerprint and collation fingerprint do not coincide.

With this method, even when incoincidence is determined by the feature point method because the pattern is distorted due to chappy skin, coincidence is determined by the amplitude suppression correlation method. On the other hand, even when incoincidence is determined by the amplitude suppression correlation method because only a partial fingerprint is obtained, and for example, the collation fingerprint is obtained at only the fingertip, coincidence is determined by the feature point method. As described above, in the combined method of this embodiment, collation and determination can be done without any error for a fingerprint that can correctly be collated by one of the methods. For this reason, the collation accuracy greatly increases as compared to collation using a single method.

The amplitude suppression correlation method may be combined with a cross correlation method (normal correlation which uses unprocessed amplitudes). Alternatively, two collation methods of the same type may be combined by combining, e.g., two feature point methods based on different feature parameter definitions. In this case, however, the collation accuracy almost equals the higher one of the two collation accuracies. That is, the collation accuracy cannot increase so greatly. In the method of this embodiment, the correlation method and feature point method are combined. When it is determined that one of the collation results indicates “coincidence (OK)”, the final collation determination result indicates “coincidence (matching)”. Hence, the collation accuracy greatly increases. This large increase in collation accuracy can also be known from the following test result.

[Test]

(1) Subjects

In this test, to obtain a clear performance difference for a small number of subjects, many persons who had poor fingerprint states and were hard to collate were intentionally collected. Twelve subjects were used, including eight males and four females in early twenties to late thirties. Seven persons had good skin surfaces. Three had dry skin and some difficulties in collation. Two remaining persons (one had serious chapping in skin and the other was suffering from atopic dermatitis) had difficulties in collation by the feature point method. In this test, the ratio of persons who had difficulties in collation was 16%, which was higher by five times or more than in random sampling. Hence, it was assumed that the user recognition ratio should also decrease to ⅕ or less.

(2) Registration

Each person registered an image of his/her right index finger.

(3) Collation

As the conformation data for user recognition of each person, 10 images of the right index finger, which were obtained at different timings, were used (12 persons×10 images=a total of 120 images).

As the conformation data for false acceptance for each person, a total of 23 fingers were used, including an adjacent finger, i.e., his/her right middle finger (one finger) and the right index fingers and right middle fingers of others (11 persons×2=22 fingers). Generally, another finger of the same person is more resemble than a finger of another person. When an adjacent finger of the same person is used, the deficiency in number of samples can be compensated for, and the reliability of false acceptance data can be increased.

The number of times of collation was as follows.

For user recognition: 12 persons×10 images of right index fingers of respective persons=collation of 120 times

For recognition of others: 12 persons×(11 other persons×two fingers (22 fingers)+right middle finger (one finger) of same person)=collation of 276 times

(4) Test Result

The recognition performance is represented by two factors, i.e., FRR (False Rejection Rate) and FAR (False Acceptance Rate). The recognition performance is high when both the FRR and FAR are low. There is an expression method called an ROC (Receiver Operating Characteristic) curve which can represent the FRR and FAR simultaneously.

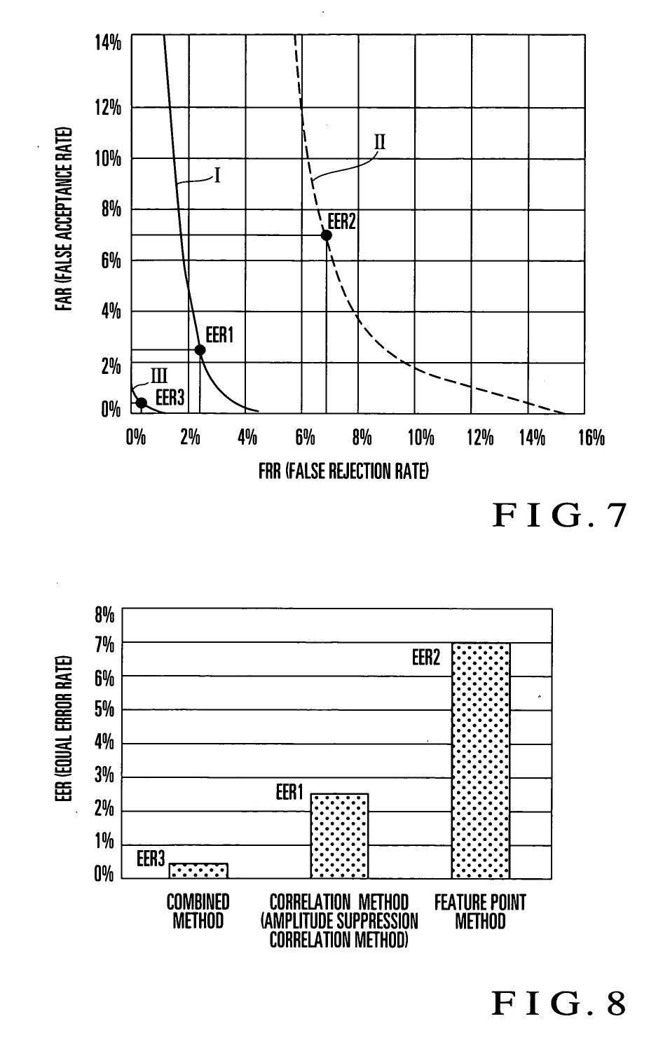

FIG. 7 shows the ROC curves of the amplitude suppression correlation method (characteristic I), the feature point method (characteristic II), and the combined method of the amplitude suppression correlation method and feature point method (characteristic III: the method of the present invention), which are obtained by the above-described test result.

In an ROC curve, a point where the FRR and FAR coincide is called an EER (Equal Error Rate) that is used as an index of recognition performance. The performance becomes high as the EER value decreases. Referring to FIG. 7, the EER (EER1) in an ROC curve I by the amplitude suppression correlation method is about 2.5%, the EER (EER2) in an ROC curve II by the feature point method is about 7%, and the EER (EER3) in an ROC curve III by the combined method is about 0.42%. FIG. 8 shows the EER1, EER2, and EER3 as bar graphs. As can be seen from FIG. 8, when the combined method of the amplitude suppression correlation method and feature point method was used, the collation accuracy greatly increased.

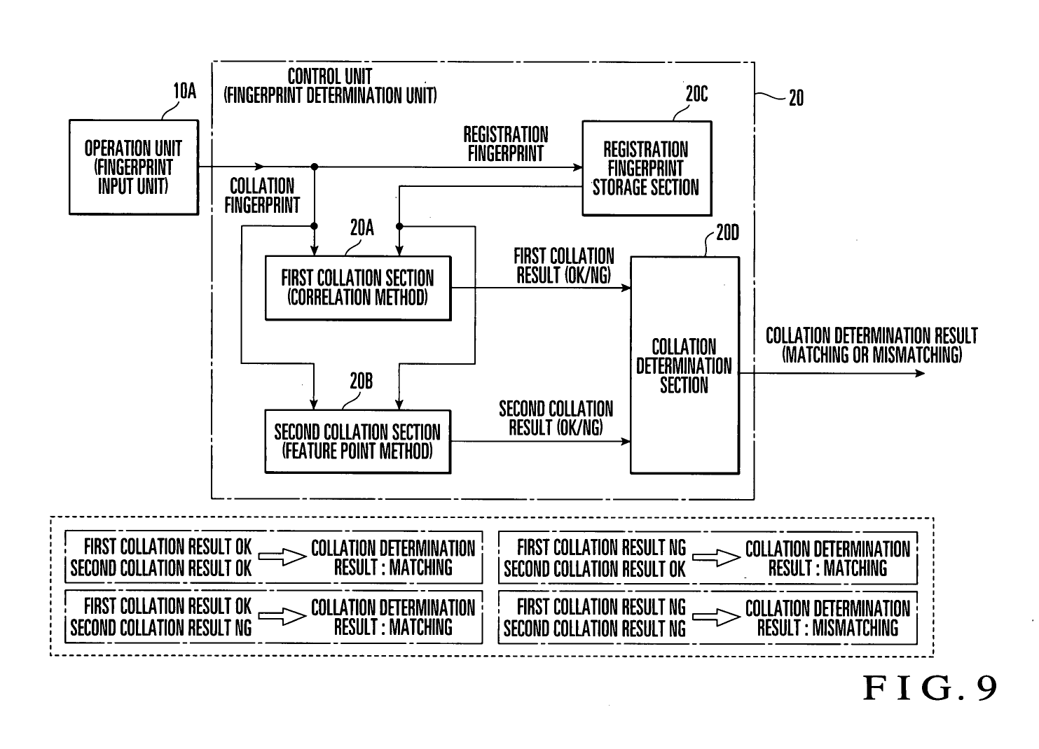

FIG. 9 shows functional blocks corresponding to the collation processing (collation method (1)) executed in accordance with the flow chart shown in FIG. 5. The control unit 20 has, as functional blocks, a first collation section 20A which executes collation by the amplitude suppression correlation method, a second collation section 20B which executes collation by the feature point method, a registration fingerprint storage section 20C, and a collation determination section 20D.

A registration fingerprint input from an operation unit 10A is stored in the registration fingerprint storage section 20C. When a collation fingerprint is input from the operation unit 10A, the collation fingerprint is supplied to the first collation section 20A and second collation section 20B. The first collation section 20A reads out the registration fingerprint from the registration fingerprint storage section 20C and collates the registration fingerprint with the collation fingerprint from the operation unit 10A by the amplitude suppression correlation method. The second collation section 20B reads out the same registration fingerprint from the registration fingerprint storage section 20C and collates the registration fingerprint with the collation fingerprint from the operation unit 10A by the feature point method. The collation result from the first collation section 20A and the collation result from the second collation section 20B are supplied to the collation determination section 20D. If the collation result by one of the methods indicates “coincidence (OK)”, the collation determination section 20D determines that the registration fingerprint and collation fingerprint “coincide (match)”.

[Fingerprint Collation: Collation Method (2) (Preferential Execution of Correlation Method)]

In the collation method (1) according to the flow chart shown in FIG. 5, collation by the amplitude suppression correlation method and collation by the feature point method are executed. If the collation result by one of the methods indicates “coincidence (OK)”, it is determined that the registration fingerprint and collation fingerprint “coincide (match)”. In the collation method (2), collation by the amplitude suppression correlation method is executed first. If the collation result by the amplitude suppression correlation method indicates “coincidence (OK)”, it is determined that the registration fingerprint and collation fingerprint “coincide (match)” without executing collation by the feature point method.

As is apparent from the above-described test result (FIGS. 7 and 8), the collation accuracy is generally higher in the amplitude suppression correlation method than in the feature point method. If the registration fingerprint and collation fingerprint are identical, collation can be finished in one cycle at a high probability by using the amplitude suppression correlation method rather than the feature point method. The total collation time required in the collation method (1) is the sum of the processing time necessary for collation by the amplitude suppression correlation method and the processing time necessary for collation by the feature point method. (The flow chart shown in FIG. 5 and the functional block diagram shown in FIG. 9 illustrate collation by the amplitude suppression correlation method and collation by the feature point method as if they were executed in parallel. However, since one CPU actually executes the processing operations, the total time is the sum of times of the two processing operations). In the collation method (2), when the collation result by the amplitude suppression correlation method indicates coincidence, collation by the feature point method is not executed. Hence, the collation determination result can quickly be obtained (this applies to most cases because the collation accuracy is higher in the amplitude suppression correlation method than in the feature point method). Even when the fingerprint cannot be correctly collated by the amplitude suppression correlation method, it can correctly be collated by the feature point method. Hence, the collation accuracy increases.

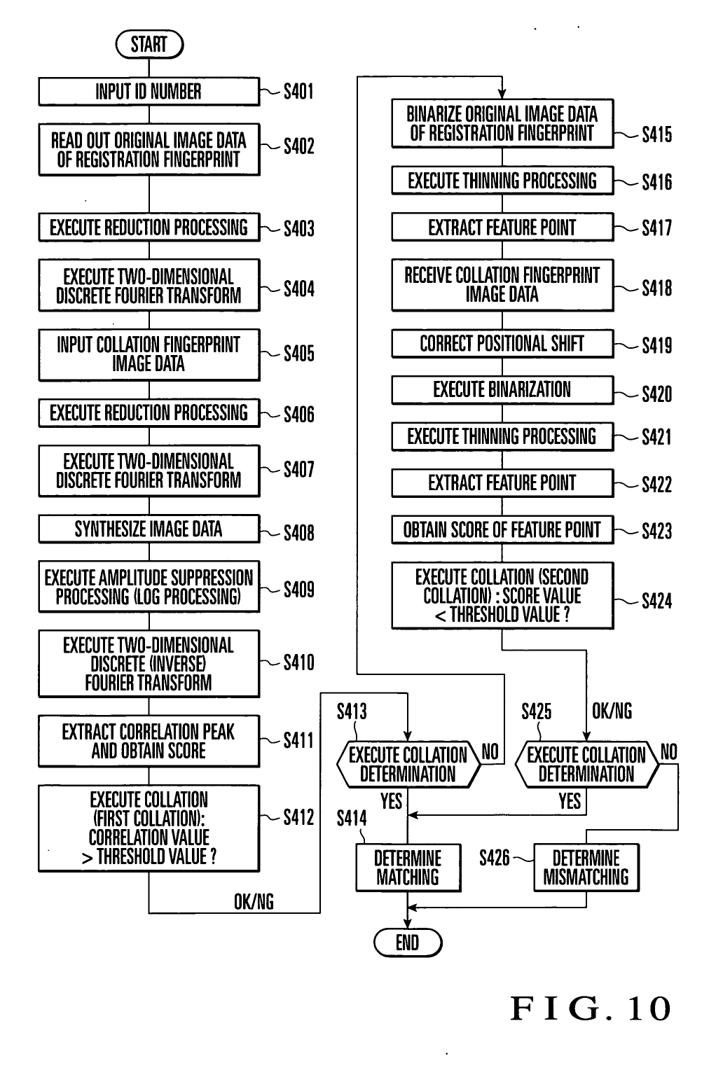

FIG. 10 shows collation by the collation method (2). As shown in this flow chart, in the collation method (2), collation by the amplitude suppression correlation method is executed in steps S401 to S412 corresponding to steps S301 to S312 in FIG. 5. When it is confirmed that the collation result by the amplitude suppression correlation method is “coincidence (OK)” (YES in step S413), it is immediately determined that the registration fingerprint and collation fingerprint “coincide (match)” (step S414).

To the contrary, when it is confirmed that the collation result by the amplitude suppression correlation method is “incoincidence (NG)” (NO in step S413), collation by the feature point method is executed in steps S415 to S424 corresponding to steps S313 to S322 in FIG. 5. When it is confirmed that the collation result by the feature point method is “coincidence (OK)” (YES in step S425), it is determined that the registration fingerprint and collation fingerprint “coincide (match)” (step S414). If the collation result by the feature point method also indicates “incoincidence (NG)” (NO in step S425), it is determined that the registration fingerprint and collation fingerprint “do not coincide (mismatch)” (step S426).

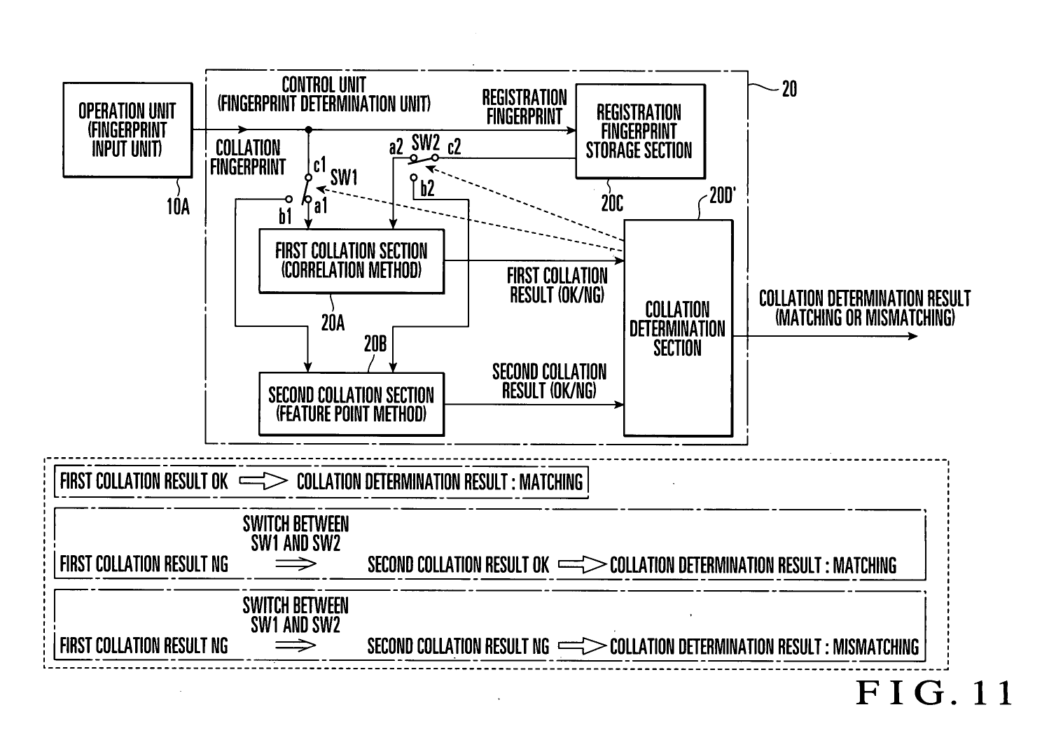

FIG. 11 shows functional blocks corresponding to the collation processing (collation method (2)) executed in accordance with the flow chart shown in FIG. 10. The control unit 20 has, as functional blocks, the first collation section 20A which executes collation by the amplitude suppression correlation method, the second collation section 20B which executes collation by the feature point method, the registration fingerprint storage section 20C, and a collation determination section 20D′.

The collation fingerprint input line to the first collation section 20A and second collation section 20B has a changeover switch SW1. The registration fingerprint input line to the first collation section 20A and second collation section 20B has a changeover switch SW2. In the changeover switch SW1, the conduction path between terminals c1 and a1 is normally ON. In the changeover switch SW2, the conduction path between terminals c2 and a2 is normally ON. The conduction paths are switched to b1 and b2 sides, respectively, in accordance with a command from the collation determination section 20D′.

A registration fingerprint from the operation unit 10A is stored in the registration fingerprint storage section 20C. When a collation fingerprint is input from the operation unit 10A, the collation fingerprint is supplied to the first collation section 20A through the changeover switch SW1. The first collation section 20A reads out the registration fingerprint from the registration fingerprint storage section 20C through the changeover switch SW2, collates the readout registration fingerprint with the collation fingerprint from the operation unit 10A by the amplitude suppression correlation method, and sends the collation result to the collation determination section 20D′. If the collation result from the first collation section 20A is “coincidence (OK)”, the collation determination section 20D′ determines that the registration fingerprint and collation fingerprint “coincide (match)”.

If the collation result from the first collation section 20A is “incoincidence (NG)”, the collation determination section 20D′ sends a switching command to the changeover switches SW1 and SW2 to turn on the conduction path between the terminals c1 and b1 of the changeover switch SW1 and the conduction path between the terminals c2 and b2 of the changeover switch SW2. Accordingly, the collation fingerprint from the operation unit 10A is supplied to the second collation section 20B through the changeover switch SW1. The second collation section 20B reads out the registration fingerprint from the registration fingerprint storage section 20C through the changeover switch SW2, collates the readout registration fingerprint with the collation fingerprint from the operation unit 10A by the feature point method, and sends the collation result to the collation determination section 20D′. If the collation result from the second collation section 20B is “coincidence (OK)”, the collation determination section 20D′ determines that the registration fingerprint and collation fingerprint “coincide (match)”.

[Fingerprint Collation: Collation Method (3) (Preferential Execution of Feature Point Method)]

In the collation method (2), collation by the amplitude suppression correlation method is executed first. If the collation result by the amplitude suppression correlation method indicates “coincidence (OK)”, it is determined that the registration fingerprint and collation fingerprint “coincide (match)” without executing collation by the feature point method. In the collation method (3), collation by the feature point method is executed first. If the collation result by the feature point method indicates “coincidence (OK)”, it is determined that the registration fingerprint and collation fingerprint “coincide (match)” without executing collation by the amplitude suppression correlation method.

According to the collation method (3), when the attribute of a pattern to be collated is suitable for the feature point method (for example, when the feature points are clear, the pattern is resistant to disturbance, or the pattern does not deform), or 1-to-N collation (a method of collating one collation pattern with N registration patterns) should be executed, the arithmetic amount for collation can be small. For this reason, the collation accuracy increases, and the collation result can be obtained in a short time. More specifically, in the amplitude suppression correlation method, arithmetic processing is executed to obtain correlation values by using all pixel data in a collation pattern. Hence, a long time is taken to obtain a collation result. On the other hand, in the feature point method, arithmetic processing is executed using only the pixel data of feature points in registration and collation patterns. Hence, the amount of data to be processed is small, and a collation result can be obtained in a short time. Especially, the time difference between 1-to-N collation and 1-to-1 collation acceleratively increase.

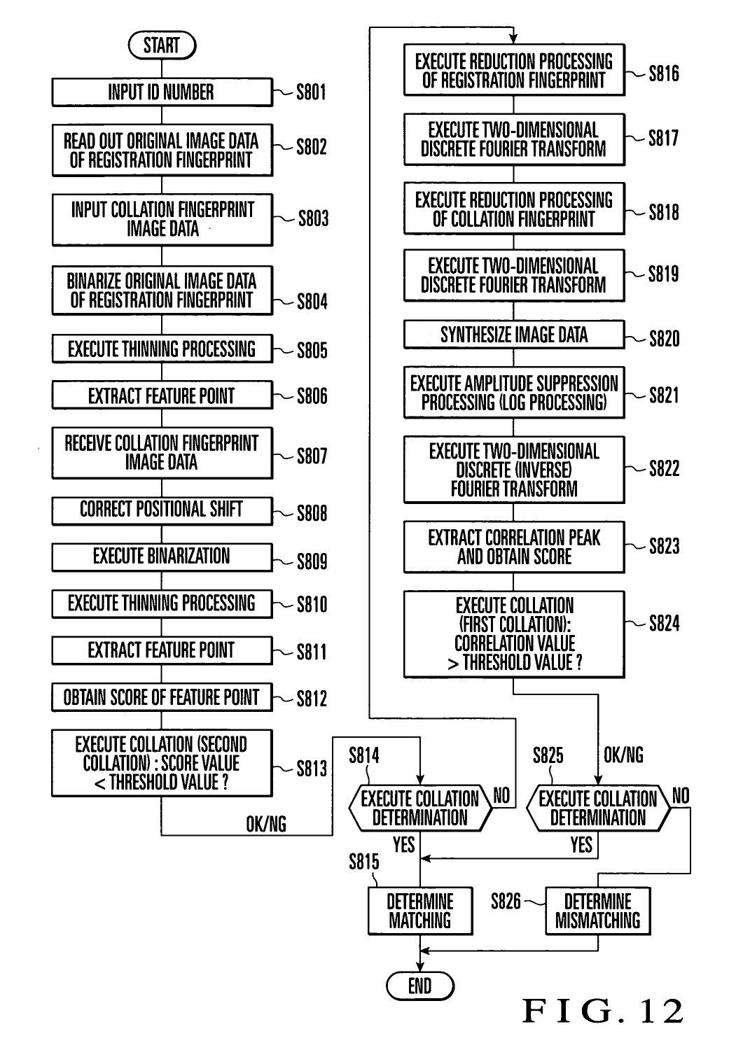

FIG. 12 shows collation by the collation method (3). As shown in this flow chart, in the collation method (3), collation by the feature point method is executed in steps S801 to S813 corresponding to steps S301, S302 and S313 to S322 in FIG. 5. When it is confirmed that the collation result by the feature point method is “coincidence (OK)” (YES in step S814), it is immediately determined that the registration fingerprint and collation fingerprint “coincide (match)” (step S815).

To the contrary, when it is confirmed that the collation result by the feature point method is “incoincidence (NG)” (NO in step S814), collation by the amplitude suppression collation method is executed in steps S816 to S824 corresponding to steps S303 to S312 in FIG. 5. When it is confirmed that the collation result by the amplitude suppression collation method is “coincidence (OK)” (YES in step S825), it is determined that the registration fingerprint and collation fingerprint “coincide (match)” (step S815). If the collation result by the amplitude suppression collation method also indicates “incoincidence (NG)” (NO in step S825), it is determined that the registration fingerprint and collation fingerprint “do not coincide (mismatch)” (step S826).

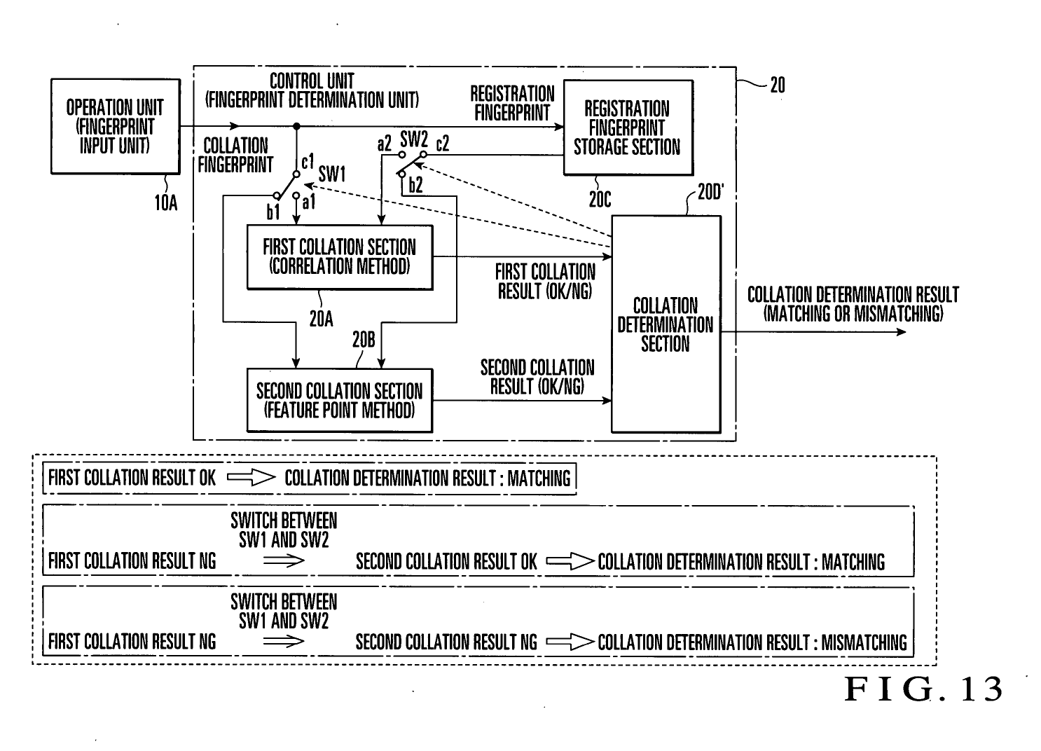

FIG. 13 shows functional blocks corresponding to the collation processing (collation method (3)) executed in accordance with the flow chart shown in FIG. 12. Referring to this functional block diagram, in the changeover switch SW1, the conduction path between the terminal c1 and a terminal b1 is normally ON. In the changeover switch SW2, the conduction path between the terminal c2 and a terminal b2 is normally ON. The conduction paths are switched to the a1 and a2 sides, respectively, in accordance with a command from the collation determination section 20D′.

A registration fingerprint from the operation unit 10A is stored in the registration fingerprint storage section 20C. When a collation fingerprint is input from the operation unit 10A, the collation fingerprint is supplied to the second collation section 20B through the changeover switch SW1. The second collation section 20B reads out the registration fingerprint from the registration fingerprint storage section 20C through the changeover switch SW2, collates the readout registration fingerprint with the collation fingerprint from the operation unit 10A by the feature point method, and sends the collation result to the collation determination section 20D′. If the collation result from the second collation section 20B is “coincidence (OK)”, the collation determination section 20D′ determines that the registration fingerprint and collation fingerprint “coincide (match)”.

If the collation result from the second collation section 20B is “incoincidence (NG)”, the collation determination section 20D′ sends a switching command to the changeover switches SW1 and SW2 to turn on the conduction path between the terminals c1 and a1 of the changeover switch SW1 and the conduction path between the terminals c2 and a2 of the changeover switch SW2. Accordingly, the collation fingerprint from the operation unit 10A is supplied to the first collation section 20A through the changeover switch SW1. The first collation section 20A reads out the registration fingerprint from the registration fingerprint storage section 20C through the changeover switch SW2, collates the readout registration fingerprint with the collation fingerprint from the operation unit 10A by the amplitude suppression collation method, and sends the collation result to the collation determination section 20D′. If the collation result from the first collation section 20A is “coincidence (OK)”, the collation determination section 20D′ determines that the registration fingerprint and collation fingerprint “coincide (match)”.

[Collation Method (4) (Collation Execution Order Designation)]

In the collation method (2) shown in FIG. 11 as a functional block diagram, collation by the amplitude suppression correlation method is always executed first. This processing assumes fingerprint collation. If handwritten characters should be collated, the collation accuracy is higher in collation by the feature point method than in collation by the amplitude suppression correlation method. In this case, collation by the feature point method is preferably executed first so that a determination result can quickly be obtained.

More specifically, when the compatibility (which collation method has a higher collation accuracy when collation is executed by using only one of the correlation method and the feature point method) between the two collation methods and the pattern to be collated is known in advance, the method to be used first for collation is designated. If the registration pattern and collation pattern are identical, collation can be finished in one cycle at a high probability, and the collation determination result can quickly be obtained. In the collation method (4), when patterns of a plurality of types with different pattern attributes are to be collated by using a single pattern collation apparatus, the optimum execution order can be designated at an appropriate time.

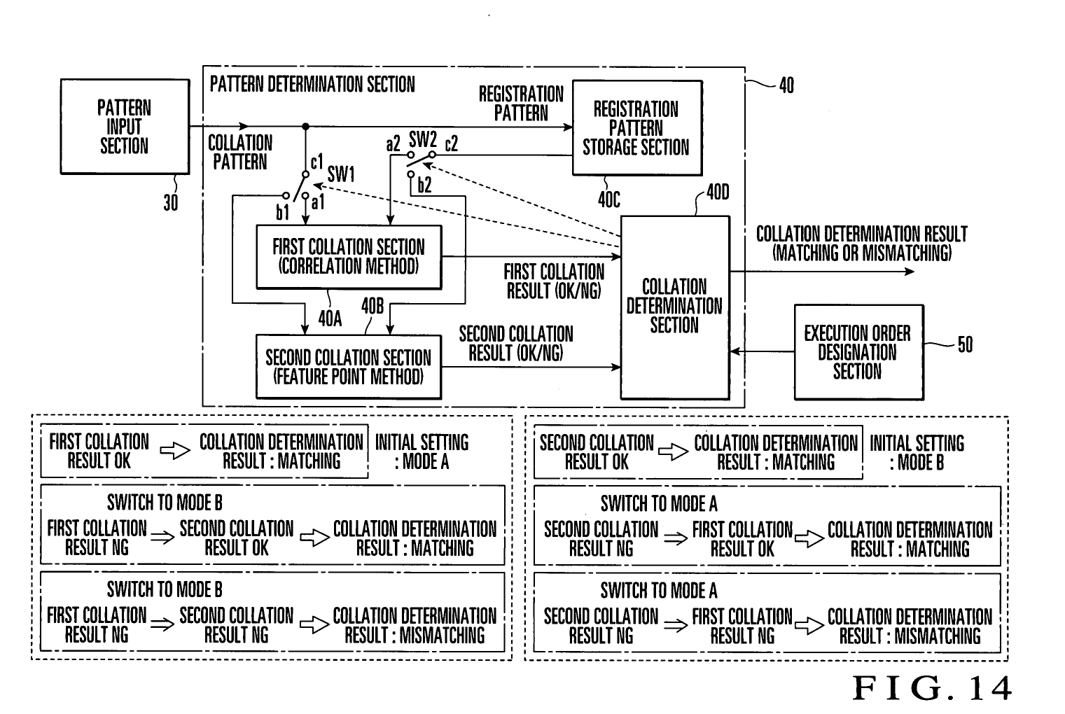

FIG. 14 shows functional blocks when the collation method (4) is employed. A pattern determination section 40 has, as functional blocks, a first collation section 40A which executes collation by the amplitude suppression correlation method, a second collation section 40B which executes collation by the feature point method, a registration pattern storage section 40C, and a collation determination section 40D.

The collation pattern input line to the first collation section 40A and second collation section 40B has the changeover switch SW1. The registration pattern input line to the first collation section 40A and second collation section 40B has the changeover switch SW2. For the changeover switch SW1, the collation determination section 40D sends an instruction so that the common terminal c1 is connected to the terminal a1 (mode A) or terminal b1 (mode B). Similarly, for the changeover switch SW2, the collation determination section 40D sends an instruction so that the common terminal c2 is connected to the terminal a2 (mode A) or terminal b2 (mode B).

[When Collation by Correlation Method (Amplitude Suppression Correlation Method) Should Be Executed First]

When designation (initial setting) is done by an execution order designation section 50 to execute collation by the amplitude suppression correlation method first, the collation determination section 40D sends a command to the changeover switches SW1 and SW2. Both the changeover switches SW1 and SW2 are set in the mode A in the initial state. More specifically, the conduction path between the common terminal c1 and the terminal a1 of the switch SW1 is set on, and the conduction path between the common terminal c2 and the terminal a2 of the switch SW2 is set on.

When a collation pattern is input from a pattern input section 30, the collation pattern is supplied to the first collation section 40A through the changeover switch SW1. The first collation section 40A reads out the registration pattern from the registration pattern storage section 40C through the changeover switch SW2, collates the readout registration pattern with the collation pattern from the pattern input section 30 by the amplitude suppression correlation method, and sends the collation result to the collation determination section 40D. If the collation result from the first collation section 40A is “coincidence (OK)”, the collation determination section 40D determines that the registration pattern and collation pattern “coincide (match)”.

If the collation result from the first collation section 40A is “incoincidence (NG)”, the collation determination section 40D sends a command to the changeover switches SW1 and SW2 to set both the changeover switches SW1 and SW2 in the mode B. More specifically, the conduction path between the terminals c1 and b1 of the changeover switch SW1 is set on, and the conduction path between the terminals c2 and b2 of the changeover switch SW2 is set on.

Accordingly, the collation pattern from the pattern input section 30 is supplied to the second collation section 40B through the changeover switch SW1. The second collation section 40B reads out the same registration pattern from the registration pattern storage section 40C through the changeover switch SW2, collates the readout registration pattern with the collation pattern from the pattern input section 30 by the feature point method, and sends the collation result to the collation determination section 40D. If the collation result from the second collation section 40B is “coincidence (OK)”, the collation determination section 40D determines that the registration pattern and collation pattern “coincide (match)”.

[When Collation by Feature Point Method Should Be Executed First]

When designation (initial setting) is done by the execution order designation section 50 to execute collation by the feature point method first, the collation determination section 40D sends a command to the changeover switches SW1 and SW2. Both the changeover switches SW1 and SW2 are set in the mode B in the initial state. More specifically, the conduction path between the common terminal c1 and the terminal b1 of the switch SW1 is set on, and the conduction path between the common terminal c2 and the terminal b2 of the switch SW2 is set on.

When a collation pattern is input from the pattern input section 30, the collation pattern is supplied to the second collation section 40B through the changeover switch SW1. The second collation section 40B reads out the registration pattern from the registration pattern storage section 40C through the changeover switch SW2, collates the readout registration pattern with the collation pattern from the pattern input section 30 by the feature point method, and sends the collation result to the collation determination section 40D. If the collation result from the second collation section 40B is “coincidence (OK)”, the collation determination section 40D determines that the registration pattern and collation pattern “coincide (match)”.

If the collation result from the second collation section 40B is “incoincidence (NG)”, the collation determination section 40D sends a command to the changeover switches SW1 and SW2 to set both the changeover switches SW1 and SW2 in the mode A. More specifically, the conduction path between the terminals c1 and a1 of the changeover switch SW1 is set on, and the conduction path between the terminals c2 and a2 of the changeover switch SW2 is set on.

Accordingly, the collation pattern from the pattern input section 30 is supplied to the first collation section 40A through the changeover switch SW1. The first collation section 40A reads out the same registration pattern from the registration pattern storage section 40C through the changeover switch SW2, collates the readout registration pattern with the collation pattern from the pattern input section 30 by the amplitude suppression correlation method, and sends the collation result to the collation determination section 40D. If the collation result from the first collation section 40A is “coincidence (OK)”, the collation determination section 40D determines that the registration pattern and collation pattern “coincide (match)”.

[Collation Method (5) (Automatic Collation Execution Order Designation)]

In the collation method (5), when patterns of a plurality of types with different pattern attributes are to be collated by using a single pattern collation apparatus, the optimum execution order is automatically be designated at an appropriate time. In this automatic execution order designation, collation by a collation method suitable for each collation pattern is preferentially executed. For example, when the area of the collation pattern is small, or the collation pattern has a high image quality, collation by the feature point method is executed first. Hence, both the collation accuracy and the collation speed can be increased.

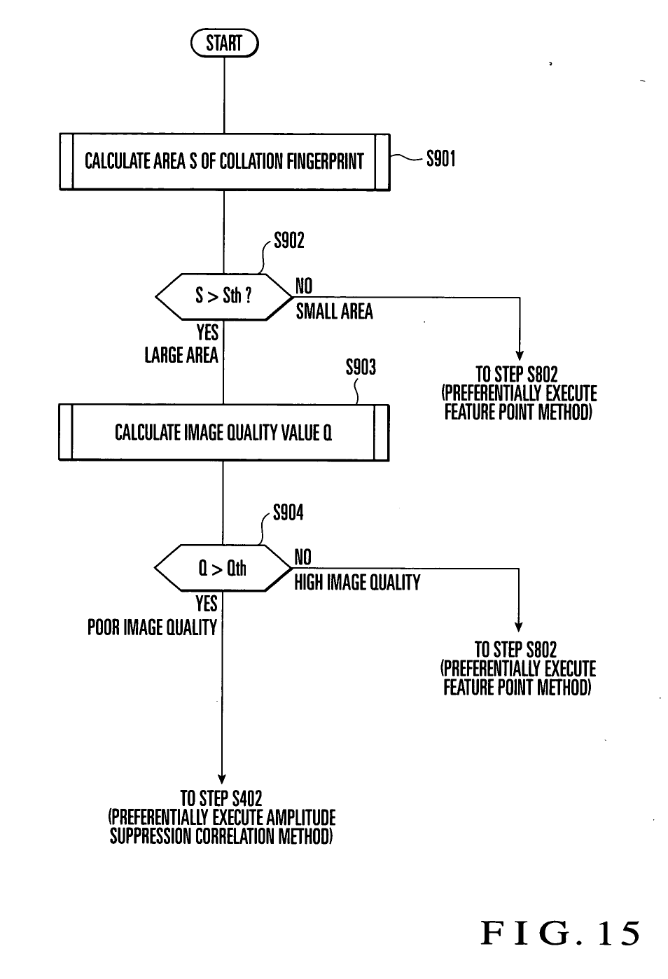

FIG. 15 shows collation by the collection method (5). As shown in this flow chart, in the collation method (5), the area S of the collation fingerprint is calculated (step S901). The calculated collation area S is compared with the predetermined threshold value Sth. When S≦Sth (NO in step S902: small area), the flow advances to step S802 in FIG. 12 to execute fingerprint collation by the collation method (3) (preferential execution of feature point method).

When S>Sth (YES in step S902: large area), the image quality value Q of the collation fingerprint is calculated (step S903). The calculated image quality value Q is compared with a predetermined threshold value Qth. When Q≦Qth (NO in step S904: high image quality), the flow advances to step S802 in FIG. 12 to execute fingerprint collation by the collation method (3) (preferential execution of feature point method). When Q>Qth (YES in step S904: poor image quality), the flow advances to step S402 in FIG. 10 to execute fingerprint collation by the collation method (2) (preferential execution of correlation method). Calculation of the collation area S in step S901 and calculation of the image quality value Q in step S903 are executed in accordance with the same procedures as those described with reference to the flow chart in FIG. 3, and a description thereof will be omitted here.

In the collation method (5), the image of the collation fingerprint is inspected first to confirm whether the collation fingerprint has a sufficient area and high image quality. When the amplitude suppression correlation method is used for a collation fingerprint having a small area, it is erroneously recognized as “incoincidence” at a high probability because collation is done on the basis of the similarity of the entire image. In such a case, the feature point method is more appropriate, and collation by the feature point method is executed first. When the image has a high quality and clear feature points but also contains a large distortion, the fingerprint is still erroneously recognized as “incoincidence” at a high probability by the amplitude suppression correlation method. In this case, not collation by the amplitude suppression correlation method but collation by the feature point method is executed first.

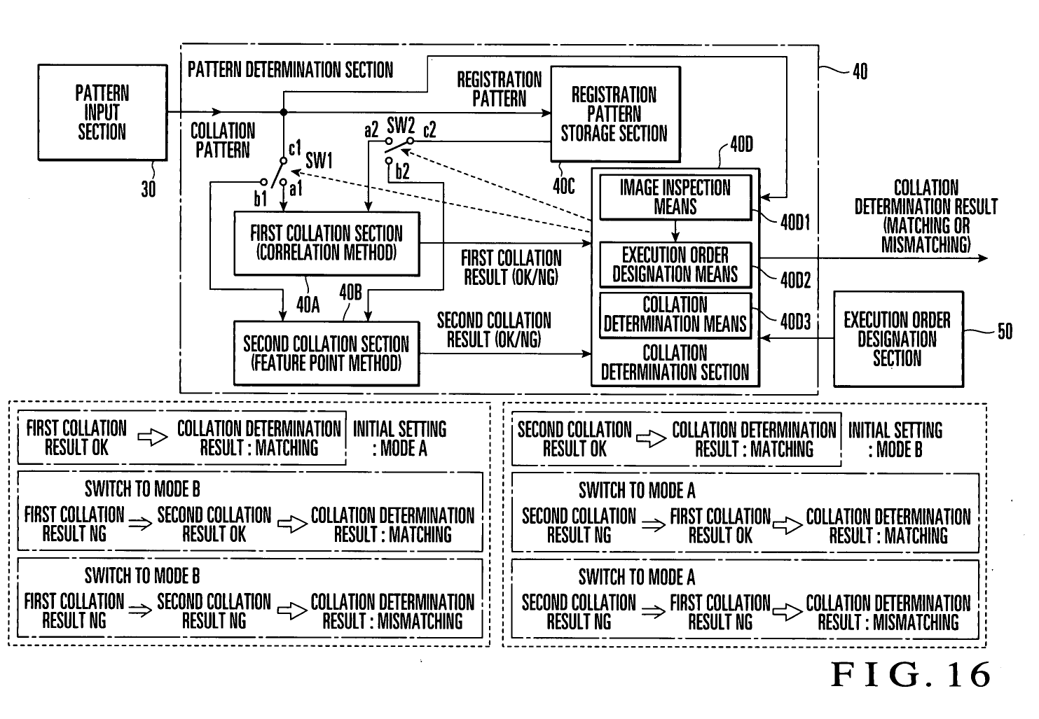

FIG. 16 shows functional blocks when the collation method (5) is employed. Referring to the functional block diagram, the collation determination section 40D has an image inspection means 40D1, execution order designation means 40D2, and collation determination means 40D3. The image inspection means 40D1 that forms part of the collation determination section 40D inspects the area and image quality of a collation pattern and sends the inspection result to the execution order designation means 40D2. When the collation pattern has a small area or a high image quality, the execution order designation means 40D2 sends a command to the changeover switches SW1 and SW2 to set both of them in the mode B on the basis of the inspection result from the image inspection means 40D1. More specifically, the conduction path between the terminals c1 and b1 of the changeover switch SW1 is set on, and the conduction path between the terminals c2 and b2 of the changeover switch SW2 is set on. When the collation pattern has a large area or a poor image quality, a command is sent to the changeover switches SW1 and SW2 to set both of them in the mode A. More specifically, the conduction path between the terminals c1 and a1 of the changeover switch SW1 is set on, and the conduction path between the terminals c2 and a2 of the changeover switch SW2 is set on.

In the flow chart shown in FIG. 5, the original image data of the registration fingerprint is read out (step S302), and reduction processing and two-dimensional discrete Fourier transform are executed for the readout original image data of the registration fingerprint (steps S303 and S304) at the time of collation. However, these processing operations may be executed for the original image data of the registration fingerprint at the time of registration, and a file of the processed data may be created as registration data. In this case, the collation time can be shortened. This also applies to the flow charts shown in FIGS. 10 and 12.

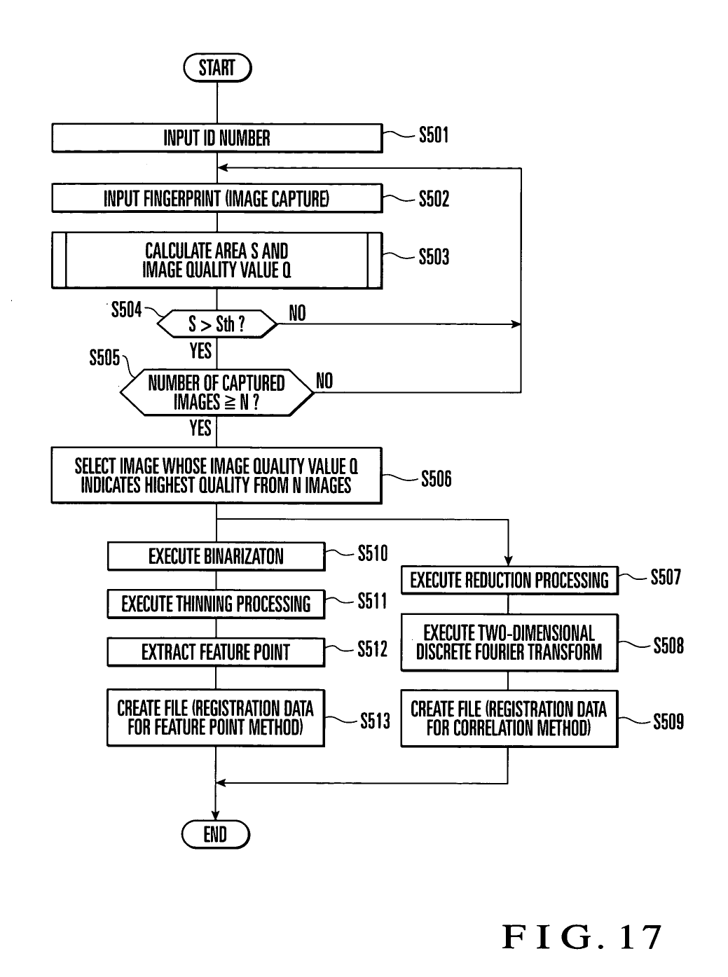

FIG. 17 shows processing in which the reduction processing and two-dimensional discrete Fourier transform, which are necessary for collation by the correlation method and the binarization processing, thinning processing, and feature point extraction, which are necessary for collation by the feature point method, are executed for the original image data of a registration fingerprint in advance to prepare and register registration data for the correlation method and registration data for the feature point method to shorten the collation time. After processing in steps S501 to S506 corresponding to steps S101 to S106 in the flow chart of FIG. 2 is executed, reduction processing and two-dimensional discrete Fourier transform are executed for registration fingerprint image data selected in step S506 (steps S507 and S508). A file of the image data is created as registration data for the amplitude suppression correlation method (step S509). In addition, binarization processing, thinning processing, and feature point extraction are also executed for the registration fingerprint image data selected in step S506 (steps S510, S511, and S512). A file is created as registration data for the feature point method (step S513).

In the flow chart shown in FIG. 5 (FIG. 10 or 12), two-dimensional discrete Fourier transform is executed in step S310 (S410 or S819). Instead of two-dimensional discrete Fourier transform, two-dimensional discrete inverse Fourier transform may be executed. More specifically, not two-dimensional discrete Fourier transform but two-dimensional discrete inverse Fourier transform may be executed for synthesized Fourier image data that has undergone amplitude suppression processing. Two-dimensional discrete Fourier transform and two-dimensional discrete inverse Fourier transform quantitatively have the same collation accuracy. The two-dimensional discrete inverse Fourier transform is described in reference 1.

In the flow chart shown in FIG. 5 (FIG. 10 or 12), amplitude suppression processing is executed for synthesized Fourier image data, and then two-dimensional discrete Fourier transform is executed (steps S309 and S310 (S409 and S410 or S821 and S822)). Instead, amplitude suppression processing may be executed for each of the Fourier image data of the registration fingerprint and that of the collation fingerprint before synthesis, and then the two Fourier image data may be synthesized.

The amplitude suppression ratio of the synthesized Fourier image data at this time is lower than that when synthesized Fourier image data is subjected to amplitude suppression processing. Hence, the collation accuracy is higher when amplitude suppression processing is executed for synthesized Fourier image data than when synthesized Fourier image data is generated after amplitude suppression processing. Even when the synthesized Fourier image data is generated after amplitude suppression processing, not two-dimensional discrete Fourier transform but two-dimensional discrete inverse Fourier transform may be executed for the synthesized Fourier image data.

In the flow chart shown in FIG. 10, the correlation value obtained in step S411 is compared with only one predetermined threshold value (step S412). When the correlation value is equal to or smaller than the only threshold value, it is determined that the collation result by the amplitude suppression correlation method indicates “incoincidence (NG)”, and collation by the feature point method is executed. However, a first threshold value and second threshold value may be defined (first threshold value>second threshold value). Only when the correlation value falls between the first threshold value and the second threshold value, collation by the feature point method may be executed. In this case, when the correlation value is equal to or less than the second threshold value, it is determined that coincidence is unlikely obtained even by the feature point method and that the registration fingerprint and collation fingerprint “do not coincide (mismatch)”.

In the above-described embodiment, amplitude suppression correlation is used as an example of the correlation method. However, a cross correlation method (a normal correlation method which uses unprocessed amplitudes) or a correlation method based on an Euclidean distance (a correlation method which uses a distance for an amplitude after Fourier transform or “rotation-invariant amplitude suppression correlation method” (an amplitude suppression correlation method which corrects the rotational shift between a registration pattern and a collation pattern) disclosed in Japanese Patent Laid-Open No. 10-124667) may be used.

[Second Embodiment (Seventh and Eighth Inventions): Rotation-Invariant Amplitude Suppression Correlation Method (Amplitude Suppression+Presence of Phase)+Amplitude Suppression Correlation Method+Feature Point Method]

In the second embodiment, two-dimensional discrete Fourier transform is executed for registration fingerprint image data R to generate registration Fourier image data R_{P}. Two-dimensional discrete Fourier transform is executed for collation fingerprint image data I to generate collation Fourier image data I_{P}. The coordinate system of the registration Fourier image data R_{P} and collation Fourier image data I_{P} is transformed into a polar coordinate system. Registration Fourier image data R_{P} and collation Fourier image data I_{P} transformed into the polar coordinate system are collated by using the amplitude suppression correlation method (coarse collation: first collation).

When no collation result indicating coincidence is obtained by the first collation, a rotational shift amount Δθ between the two image data is obtained from the position of the correlation peak obtained in the collation process of the first collation. On the basis of the obtained rotational shift amount Δθ, rotation shift correction is performed for one of the registration fingerprint and collation fingerprint. Then, the registration fingerprint and collation fingerprint are collated again by the amplitude suppression correlation method (fine collation: second collation).

When no collation result indicating coincidence is obtained by the second collation, vertical and horizontal shift amounts ΔX and ΔY between the two image data are obtained from the position of the correlation peak obtained in the collation process of the second collation. On the basis of the obtained vertical and horizontal shift amounts ΔX and ΔY and the rotational shift amount Δθ obtained from the position of the correlation peak obtained in the collation process of the first collation, rotation shift correction and vertical/horizontal shift correction are performed for one of the registration pattern and collation pattern. Then, the registration pattern and collation pattern are collated by the feature point method (third collation).

The fingerprint collation operation according to the second embodiment will be described below in detail with reference to flow charts.

[Fingerprint Registration]

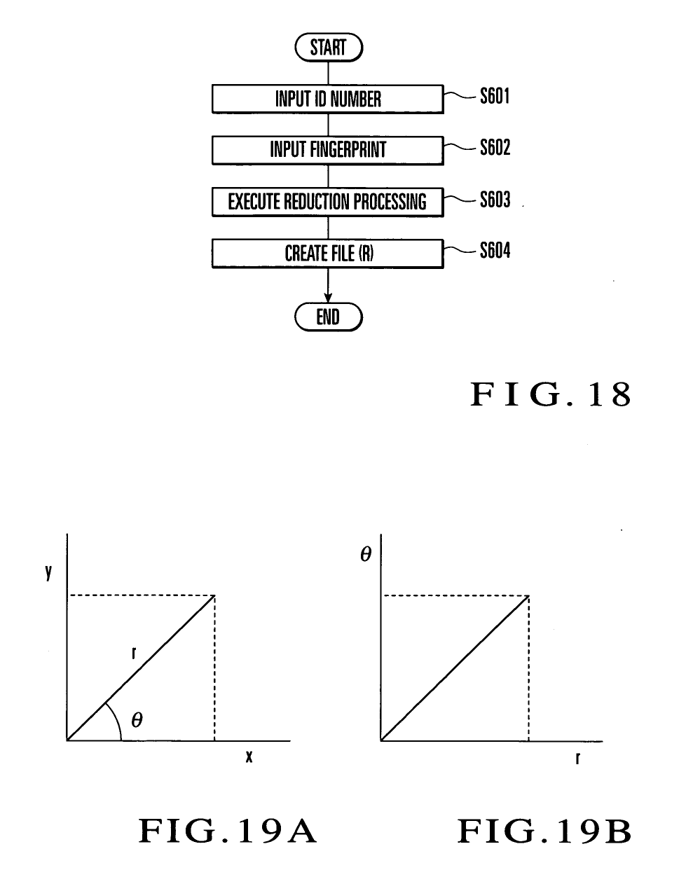

In the second embodiment, as shown in the flow chart of FIG. 18, processing in steps S601 and S602 is executed in correspondence with steps S101 and S102 in FIG. 2. A file of the registration fingerprint image data R that is reduced in step S603 is created as the original image data of the registration fingerprint in correspondence with an ID number (step S604). Two-dimensional discrete Fourier transform may be executed for the registration fingerprint image data R to generate the registration Fourier image data R_{P}, and a file of the registration Fourier image data R_{P} may be created as the original image data of the registration fingerprint in correspondence with the ID number.

[Fingerprint Collation]

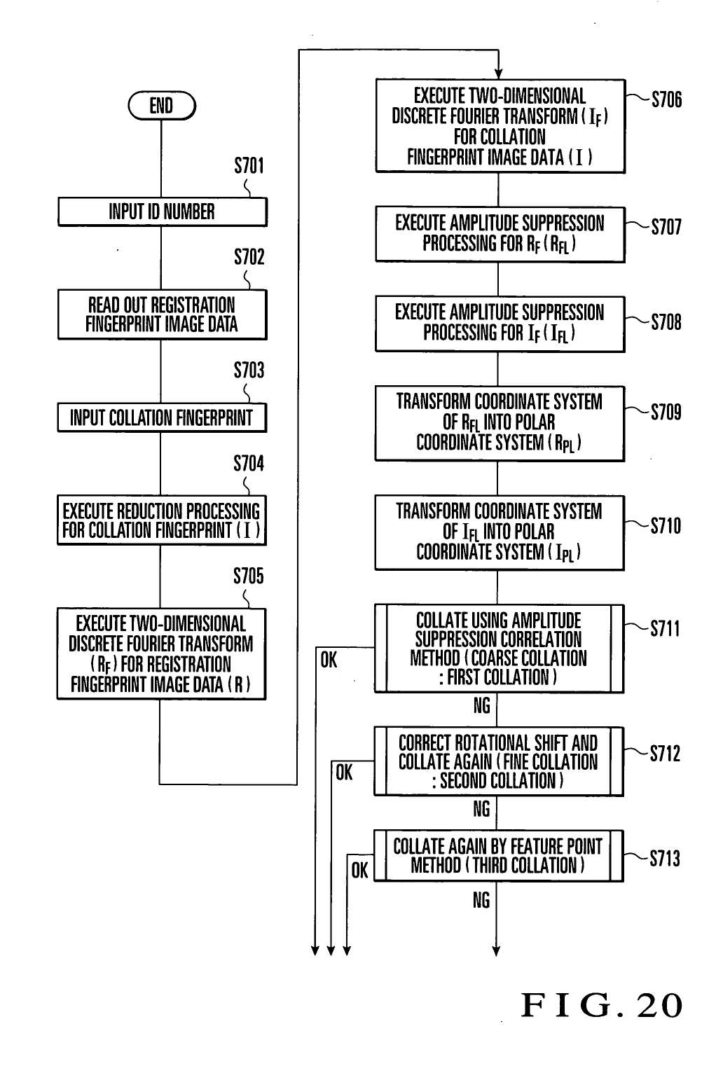

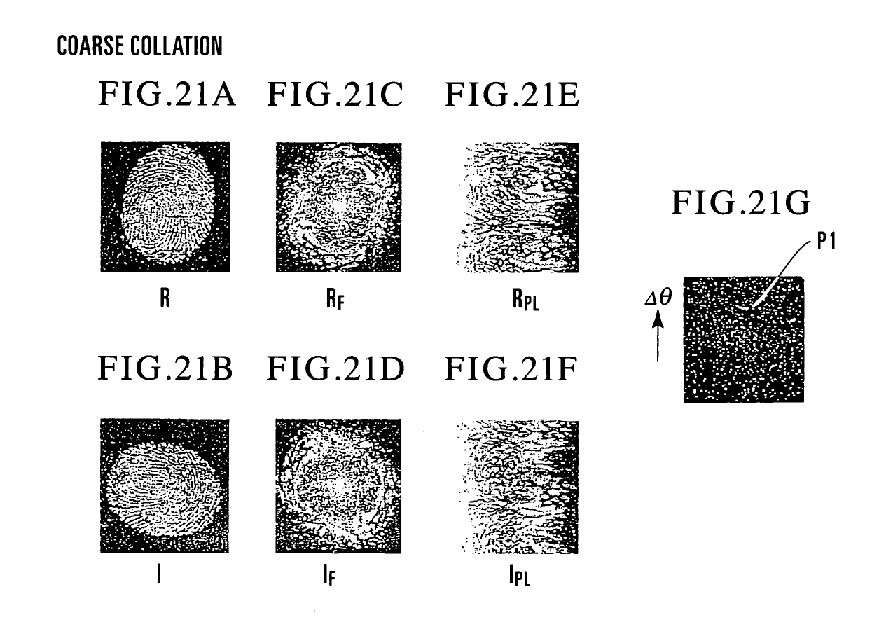

Fingerprint collation is executed in the following way. When an ID number is input (step S701 in FIG. 20), a file of the registration fingerprint image data R corresponding to the ID number is read out (step S702: FIG. 21A). A collation fingerprint is input (step S703). Reduction processing is executed for the collation fingerprint (step S704) to obtain the collation fingerprint image data I (FIG. 21B). Two-dimensional discrete Fourier transform is executed for the registration fingerprint image data R read out in step S702 to generate the registration Fourier image data R_{P} (step S705: FIG. 21C). Two-dimensional discrete Fourier transform is executed for the collation fingerprint image data I obtained in step S704 to generate the collation Fourier image data I_{P} (step S706: FIG. 21D).

The registration Fourier image data R_{P} and collation Fourier image data I_{P} contain amplitude components and phase components. The registration Fourier image data R_{P} and collation Fourier image data I_{P} have a Cartesian coordinate system, i.e., an (x,y) coordinate system. Amplitude suppression processing is executed for the registration Fourier image data R_{P} and collation Fourier image data I_{P} (steps S707 and S708). The coordinate system of registration Fourier image data R_{PL} and collation Fourier image data I_{PL} obtained by amplitude suppression processing is transformed into a polar coordinate system (step S709 and S710), thereby obtaining registration Fourier image data R_{PL} and collation Fourier image data I_{PL} transformed into the polar coordinate system (FIGS. 21E and 21F).

Polar coordinate transformation means processing for transforming a Cartesian coordinate system (x,y) into a polar coordinate system (r,θ). More specifically, a Cartesian coordinate system (x=rcos θ,y=rsin θ) shown in FIG. 19A is transformed into a polar coordinate system (r=(x²+y²)^{1/2}, θ=tan⁻¹(y/x)) shown in FIG. 19B.

[Coarse Collation (First Collation)]

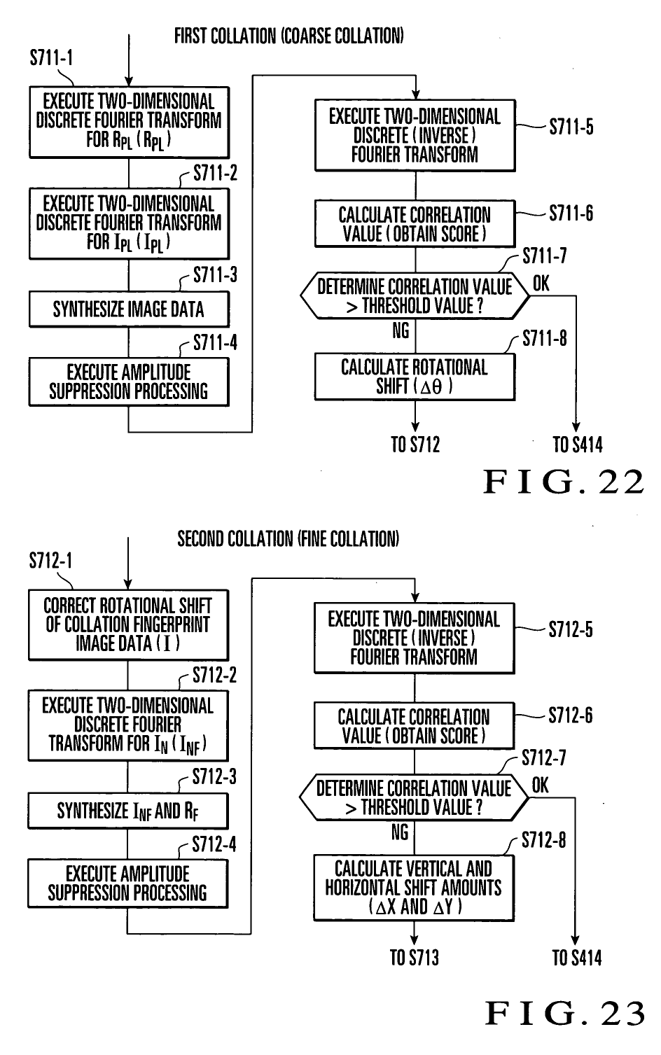

The registration Fourier image data R_{PL} transformed into the polar coordinate system in step S709 is collated by the amplitude suppression correlation method with the collation Fourier image data I_{PL} transformed into the polar coordinate system in step S710 (step S711). FIG. 22 shows the collation process.

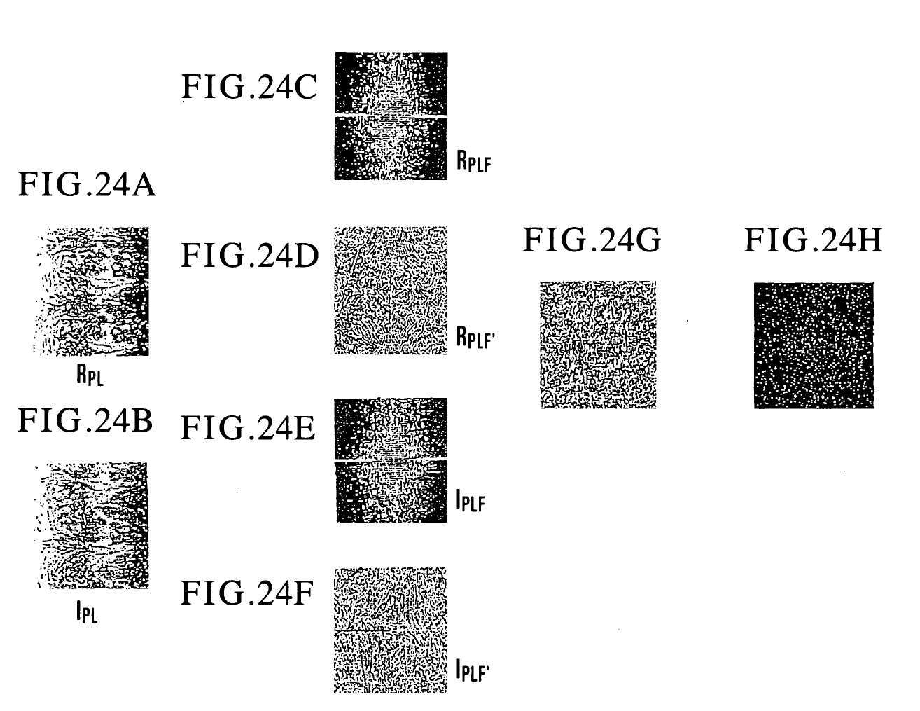

In this case, two-dimensional discrete Fourier transform is executed for the registration Fourier image data R_{PL} (FIG. 24A) and collation Fourier image data I_{PL} (FIG. 24B) transformed into the polar coordinate system (steps S711-1 and S711-2) to obtain registration Fourier image data R_{PLP} (FIG. 24C) and collation Fourier image data I_{PLP} (FIG. 24E).

The registration Fourier image data R_{PLP} and collation Fourier image data I_{PLP} are synthesized (step S711-3) to obtain synthesized Fourier image data. Amplitude suppression processing is executed for the synthesized Fourier image data (step S711-4: FIG. 24G). Two-dimensional discrete Fourier transform is executed for the synthesized Fourier image data that has undergone the amplitude suppression processing (step S711-5: FIGS. 24H and 21G, FIG. 24H=FIG. 21G).

In this example, amplitude suppression processing is executed for the synthesized Fourier image data of R_{PLP} and I_{PLP}. However, the amplitude suppression processing may be executed for R_{PLP} and I_{PLP} to obtain registration Fourier image data R_{PLP}′ and collation Fourier image data I_{PLP}′ (FIGS. 24D and 24F), and R_{PLP}′ and I_{PLP}′ may be synthesized. Referring to FIGS. 24D, 24F, and 24G, all amplitudes are suppressed to 1 by amplitude suppression. That is, only phases are obtained.

The intensity (amplitude) of the correlation component of each pixel in a predetermined correlation component area is scanned from the synthesized Fourier image data that has undergone the two-dimensional discrete Fourier transform to obtain the histogram of the intensities of the correlation components of the pixels. Upper n pixels which have high correlation component intensities are extracted from the histogram. The average of the intensities of the correlation components of the n extracted pixels is obtained as a correlation value (score) (step S711-6). If the resultant correlation value is larger than a predetermined threshold value (YES in step S711-7), it is roughly determined that the registration fingerprint and collation fingerprint indicate “coincidence (OK)”. If the resultant correlation value is equal to or smaller than the predetermined threshold value (NO in step S711-7), it is determined that the registration fingerprint and collation fingerprint indicate “incoincidence (NG)”.

When it is determined by the first collation that the registration fingerprint and collation fingerprint indicate “incoincidence (NG)”, a pixel having the highest correlation component intensity is obtained, as a correlation peak, from the synthesized Fourier image data that has undergone the two-dimensional discrete Fourier transform in step S711-5. The rotational shift amount Δθ between the registration fingerprint and the collation fingerprint, i.e., the rotational shift amount Δθ between the registration fingerprint image data R and the collation fingerprint image data I is obtained from the position of the correlation peak (step S711-8).

Referring to FIG. 21G, a correlation peak P1 appears. The rotational shift amount Δθ is obtained from the positional relationship between the correlation peak P1 and the center of the correlation area. More specifically, the rotational shift amount Δθ is obtained from the vertical position of the correlation peak P1 in the area shown in FIG. 21G. In this case, the upper limit position in the vertical direction in the area is Δθ=+180°, and the lower limit position is Δθ=−180°.

[Fine Collation (Second Collation)]

When “incoincidence (NG)” is determined by the first collation, and the rotational shift amount Δθ between the registration fingerprint image data R and the collation fingerprint image data I is obtained, the rotational shift of the collation fingerprint image data I is corrected on the basis of the obtained rotational shift amount Δθ. Then, the registration fingerprint and collation fingerprint are collated again by the amplitude suppression correlation method (step S712). FIG. 23 shows the collation process.

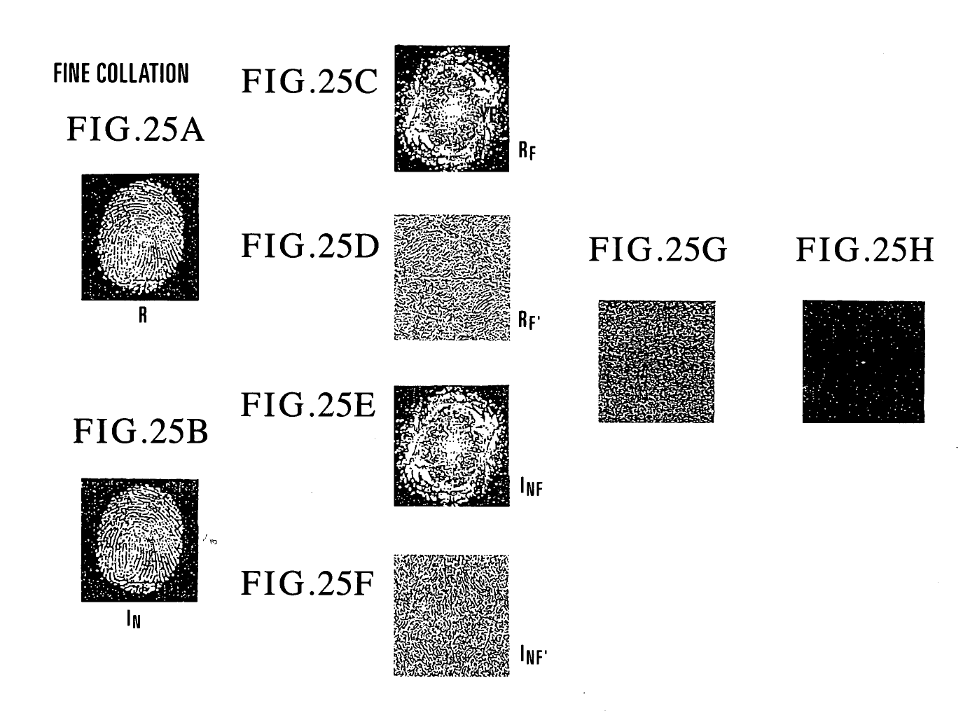

In this case, the rotational shift amount Δθ of the collation fingerprint image data I is corrected (step S712-1) to obtain image data I_{N} whose rotation angle coincides with that of the registration fingerprint image data R (FIGS. 25A and 25B). Two-dimensional discrete Fourier transform is executed for the collation fingerprint image data I_{N} (step S712-2) to obtain collation Fourier image data I_{NP} (FIG. 25E).

The collation Fourier image data I_{NP} and the registration Fourier image data R_{P} (FIG. 25C) obtained in step S705 are synthesized (step S712-3) to obtain synthesized Fourier image data. Amplitude suppression processing is executed for the synthesized Fourier image data (step S712-4). Two-dimensional discrete Fourier transform is executed for the synthesized Fourier image data (FIG. 25G) that has undergone the amplitude suppression processing (step S712-5).

The intensity (amplitude) of the correlation component of each pixel in a predetermined correlation component area is scanned from the synthesized Fourier image data (FIG. 25H) that has undergone the two-dimensional discrete Fourier transform to obtain the histogram of the intensities of the correlation components of the pixels. Upper n pixels which have high correlation component intensities are extracted from the histogram. The average of the intensities of the correlation components of the n extracted pixels is obtained as a correlation value (score) (step S712-6).

The correlation value obtained in step S712-6 is compared with a predetermined threshold value. If the correlation value is larger than the threshold value (YES in step S712-7), it is determined that the registration fingerprint and collation fingerprint indicate “coincidence (OK)”. If the correlation value is equal to or smaller than the threshold value (NO in step S712-7), it is determined that the registration fingerprint and collation fingerprint indicate “incoincidence (NG)”.

When it is determined by the second collation that the registration fingerprint and collation fingerprint indicate “incoincidence (NG)”, a pixel having the highest correlation component intensity is obtained, as a correlation peak, from the synthesized Fourier image data that has undergone the two-dimensional discrete Fourier transform in step S712-5. The vertical and horizontal shift amounts ΔX and ΔY between the registration fingerprint and the collation fingerprint, i.e., the vertical and horizontal shift amounts ΔX and ΔY between the registration fingerprint image data R and the collation fingerprint image data I is obtained from the position of the correlation peak (step S712-8).

In this example, amplitude suppression processing is executed for the synthesized Fourier image data of R_{P} and I_{NP}. However, the amplitude suppression processing may be executed for R_{P} and I_{NP} to obtain registration Fourier image data R_{P}′ and collation Fourier image data I_{NP}′ (FIGS. 25D and 25F), and R_{P}′ and I_{NP}′ may be synthesized. Referring to FIGS. 25D, 25F, and 25G, all amplitudes are suppressed to 1 by amplitude suppression. That is, only phases are obtained.

Referring to FIG. 23, the rotational shift of the collation fingerprint image data I is corrected, and the registration fingerprint and collation fingerprint are collated again. However, the rotational shift amount of the registration fingerprint image data R may be corrected, and the registration fingerprint and collation fingerprint may be collated again.

[Collation by Feature Point Method (Third Collation)]

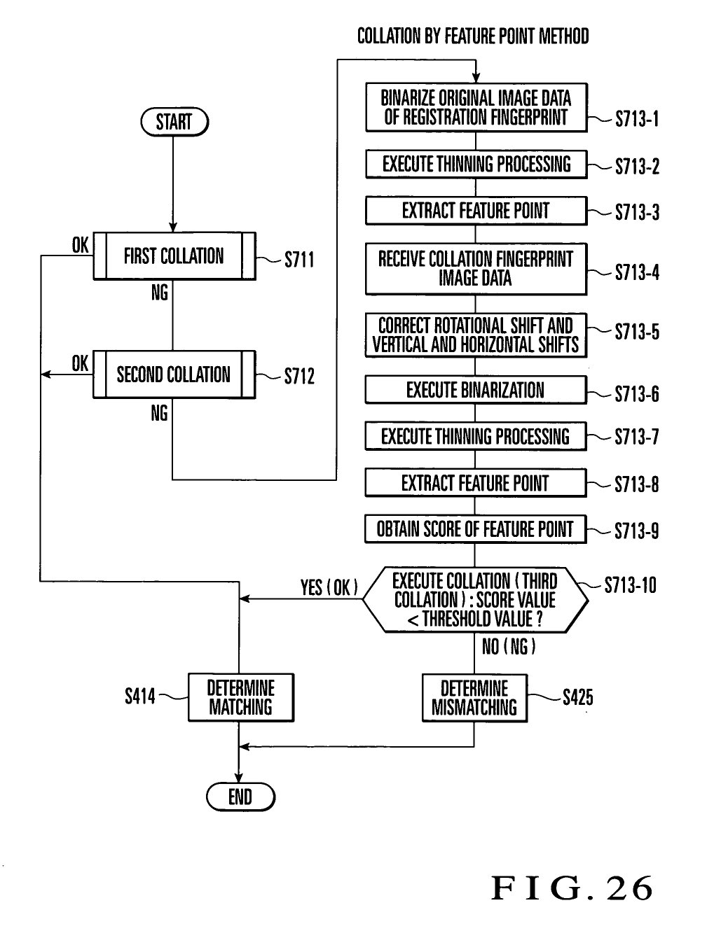

When “incoincidence (NG)” is determined by the second collation, and the vertical and horizontal shift amounts ΔX and ΔY between the registration fingerprint image data R and the collation fingerprint image data I are obtained, the rotational shift and vertical and horizontal shifts of the collation fingerprint image data I are corrected on the basis of the vertical and horizontal shift amounts ΔX and ΔY and the rotational shift amount Δθ obtained in the first collation. Then, the registration fingerprint and collation fingerprint are collated again by the feature point method (step S713). FIG. 26 shows the collation process.

In this case, when coarse collation and fine collation by the amplitude suppression correlation method are executed in steps S711 and 712 in FIG. 20, and it is confirmed that both collation results by coarse collation and fine collation by the amplitude suppression correlation method indicate “incoincidence (NG)”, collation by the feature point method is executed in steps S713-1 to S713-10 corresponding to steps S313 to S322 in FIG. 5.

In collation by the feature point method, correction of the rotational shift and vertical and horizontal shifts of the collation fingerprint image data I on the basis of the vertical and horizontal shift amounts ΔX and ΔY obtained in the second collation and the rotational shift amount Δθ obtained in the first collation is done in step S713-5. The correction of the rotational shift and vertical and horizontal shifts may be executed not for the collation fingerprint image data I but for the registration fingerprint image data R. In addition, the correction of the rotational shift and vertical and horizontal shifts need not always be executed after step S713-4. For example, when the correction should be done for the registration fingerprint image data R, this process can be inserted after one of steps S713-1 to S713-8.

When it is confirmed that the collation result by the feature point method indicates “coincidence (OK)” (YES in step S713-10), it is determined that the registration fingerprint and collation fingerprint “coincide (match)” (step S414). However, if the collation result by the feature point method also indicates “incoincidence (NG)” (NO in step S713-10), it is determined that the registration fingerprint and collation fingerprint “do not coincide (mismatch)” (step S425).

[Third Embodiment (Ninth Invention): Rotation-Invariant Amplitude Suppression Correlation Method (Amplitude Suppression+Adding Sign (±) of Phase to Amplitude)+Amplitude Suppression Correlation Method+Feature Point Method]

In the second embodiment, in coarse collation, the coordinate system of the registration Fourier image data R_{PL} and collation Fourier image data I_{PL} which contain amplitude-suppressed amplitude components and phase components is transformed into a polar coordinate system (step S709 and S710 in FIG. 20).

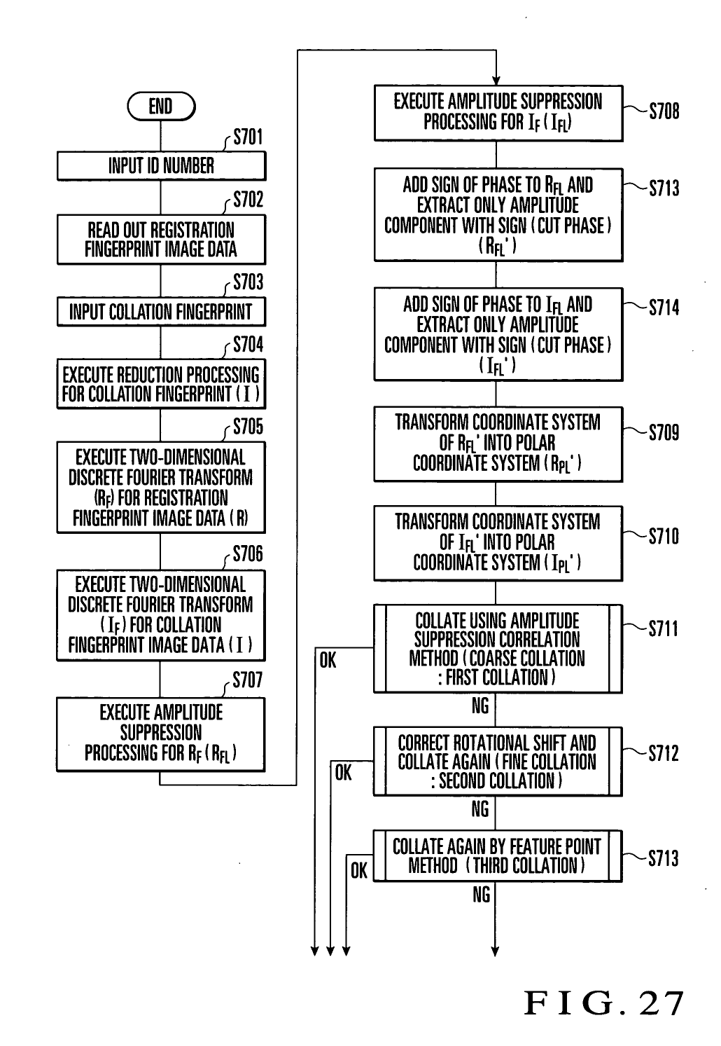

In the third embodiment, for registration Fourier image data R_{PL} and collation Fourier image data I_{PL} which have undergone amplitude suppression processing, the signs of phases are added to the amplitudes, and only amplitude components (R_{PL}′ and I_{PL}′) with signs are extracted. The coordinate system of R_{PL}′ and I_{Pl}′ is transformed into a polar coordinate system. FIG. 27 shows the flow chart of this processing.

Unlike the flow chart shown in FIG. 20, steps S713 and S714 are added in the third embodiment. For the registration Fourier image data R_{PL} and collation Fourier image data I_{PL} which have undergone amplitude suppression processing, the signs of their phases are added to the amplitudes. Only the amplitude components (R_{PL}′ and I_{PL}′) with signs are extracted. Then, the coordinate system is transformed into a polar coordinate system to obtain R_{PL}′ and I_{PL}′ (steps S709 and S710).

According to the third embodiment, for registration Fourier image data R_{P} and collation Fourier image data I_{P}, the signs of their phases are added to the amplitudes, and only the amplitude components with signs are extracted. With this arrangement, the influence of discontinuity of phases can be reduced. Hence, even when an error such as a positional shift between a registration pattern and a collation pattern is present, collation can accurately be executed.

[Fourth Embodiment (10th Invention): Rotation-Invariant Amplitude Suppression Correlation Method (Amplitude Suppression+Absence of Phase)+Amplitude Suppression Correlation Method+Feature Point Method]

In the second embodiment, amplitude suppression processing is executed for the registration Fourier image data R_{P} and collation Fourier image data I_{P}. The coordinate system of the registration Fourier image data R_{P} and collation Fourier image data I_{P} which have undergone the amplitude suppression processing is transformed into a polar coordinate system.

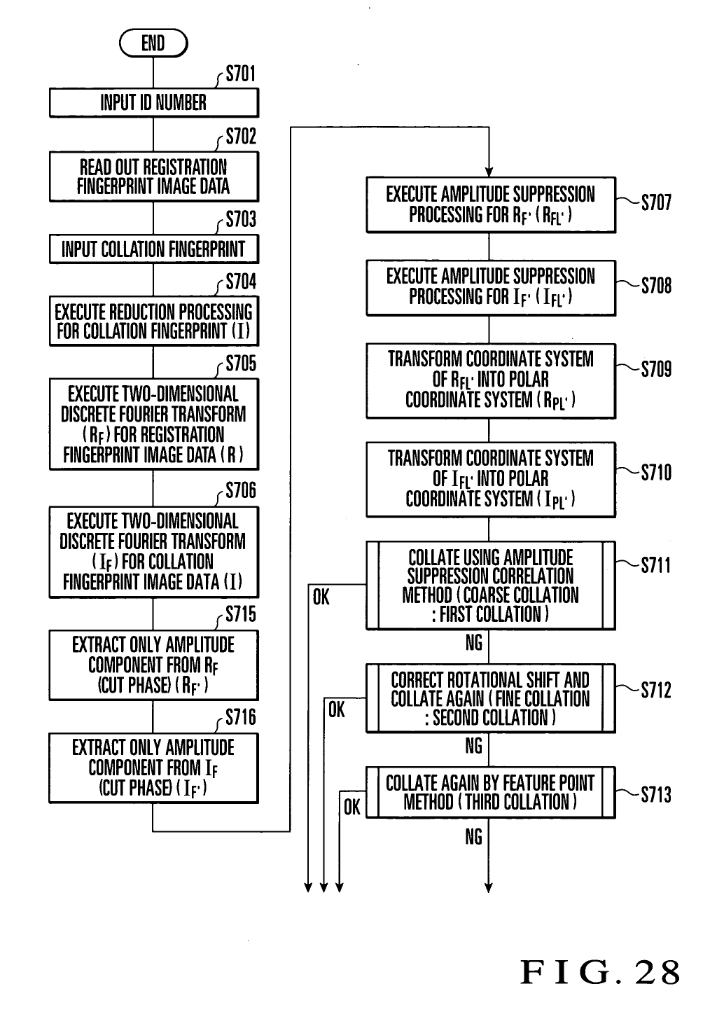

In the fourth embodiment, phase components are removed from registration Fourier image data R_{P} and collation Fourier image data I_{P}. Amplitude suppression processing is executed for registration Fourier image data R_{P}′ and collation Fourier image data I_{P}′ without phase components. The coordinate system of registration Fourier image data R_{PL}′ and collation Fourier image data I_{PL}′ that have undergone the amplitude suppression processing is transformed into a polar coordinate system. In the amplitude suppression processing, however, not the amplitude suppression processing for suppressing all amplitudes to 1 but log processing or root processing is executed. FIG. 28 shows the flow chart of this processing.

Unlike the flow chart shown in FIG. 20, steps S715 and S716 are added in the fourth embodiment. Only amplitude components are extracted (phase components are cut) from the registration Fourier image data R_{P} and collation Fourier image data I_{P} (steps S715 and S716). Amplitude suppression processing is executed for the registration Fourier image data R_{P}′ and collation Fourier image data I_{P}′ having no phase components (steps S707 and S708). The coordinate system of registration Fourier image data R_{PL}′ and collation Fourier image data I_{PL}′ that have undergone the amplitude suppression processing is transformed into a polar coordinate system to obtain R_{PL}′ and I_{PL}′ (steps S709 and S710).

According to the fourth embodiment, when the phase components are removed from the registration Fourier image data R_{P} and collation Fourier image data I_{P}, and amplitude suppression processing is executed for them, the influence of a change in illuminance becomes small. Even when the illuminance changes between the registration time and the collation time, accurate collation can be executed. In addition, the performance in obtaining the correlation peak by the amplitude suppression correlation method using polar coordinate transformation can be improved. More specifically, the continuity of pixels is poor in the phase and good in the amplitude. Hence, when the phase component is removed, the performance in obtaining the correlation peak by the amplitude suppression correlation method using polar coordinate transformation can be improved.

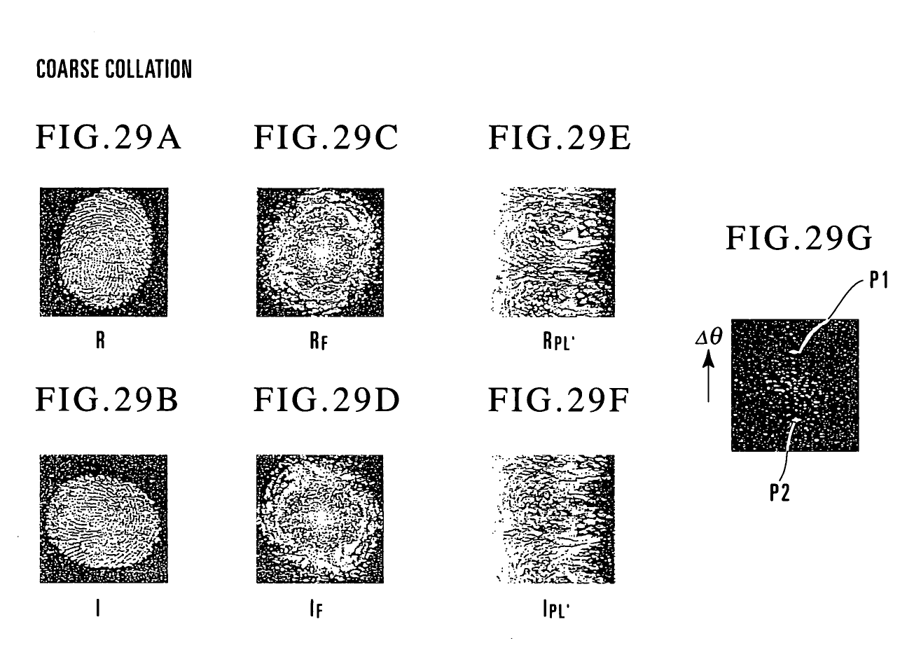

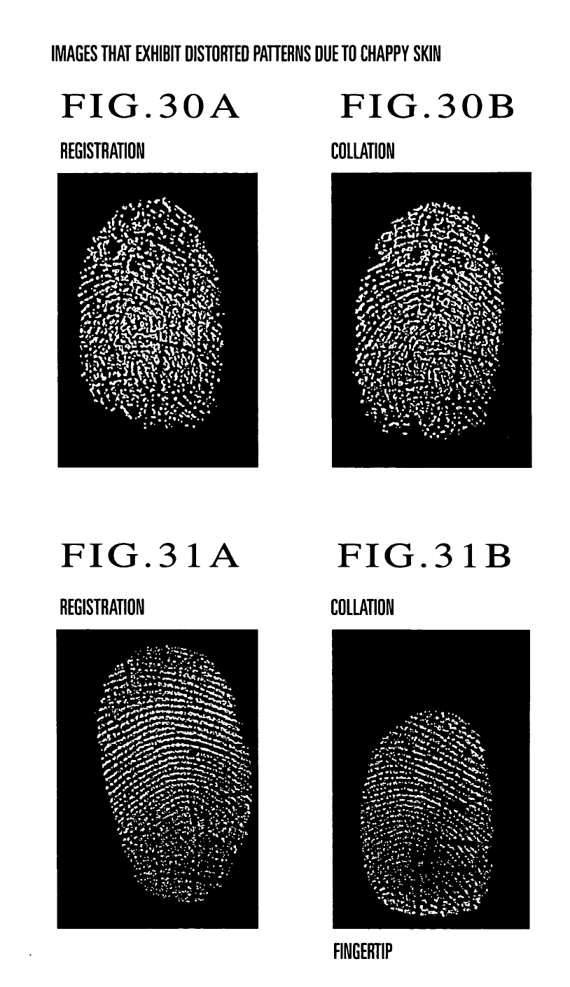

At this time, as shown in FIG. 29, correlation peaks P1 and P2 appear on the correlation component area. This is because the amplitude spectrum is point-symmetrical. By executing mask processing, one of the correlation peaks P1 and P2 is determined as a normal correlation peak that indicates a rotational shift amount Δθ including the rotational direction. The rotational shift amount Δθ is obtained from the determined correlation peak. For example, when the correlation peak P1 is determined as a normal correlation peak, the rotational shift amount Δθ is obtained from the vertical position of the correlation peak P1 in the area shown in FIG. 29. In this case, the upper limit position in the vertical direction in the area is Δθ=+180°, and the lower limit position is Δθ=−180°.

In the first to fourth embodiments described above, two-dimensional pattern collation such as fingerprint collation has been described. However, the present invention can also be applied to collation of an N-dimensional pattern including a one-dimensional pattern such as voice and a three-dimensional pattern such as a stereoscopic image.

According to the present invention, the first collation means collates a registration pattern with a collation pattern by the correlation method, the second collation means collates the registration pattern with the collation pattern by the feature point method, and it is determined on the basis of at least one collation result that the registration pattern coincides with the collation pattern. According to the present invention, when at least one of a collation result by the first collation means for executing collation by the correlation method and a collation result by the second collation means for executing collation by the feature point method indicates coincidence between the registration pattern and the collation pattern, it is determined that the registration pattern coincides with the collation pattern. Since the collation methods of different types, i.e., the correlation method and feature point method are combined, their disadvantages can be compensated for, and the collation accuracy can be made much higher than an apparatus which executes a single method.

According to the present invention, when the collation result by the first collation means for executing collation by using the correlation method indicates coincidence between the registration pattern and the collation pattern, it is determined that the registration pattern coincides with the collation pattern without executing collation by the second collation means for executing collation by using the feature point method. When the amplitude suppression correlation method having a higher collation accuracy than that of the feature point method is used as the correlation method, the collation determination result can quickly be obtained. In addition, even when the collation pattern is a pattern that cannot be correctly collated by the correlation method, it can correctly be collated by the feature point method. Hence, the collation accuracy increases.

According to the present invention, when the collation result by the second collation means for executing collation by using the feature point method indicates coincidence between the registration pattern and the collation pattern, it is determined that the registration pattern coincides with the collation pattern without executing collation by the first collation means for executing collation by using the correlation method. When the attribute of the pattern to be collated is suitable for the feature point method (for example, when the feature points are clear, the pattern is resistant to disturbance, or the pattern does not deform), or 1-to-N collation (a method of collating one collation pattern with N registration patterns) should be executed, the arithmetic amount for collation can be small. For this reason, the collation accuracy increases, and the collation result can be obtained in a short time.

According to the present invention, an execution order designation means for allowing designation of the execution order of collation by the correlation method and collation by the feature point method is arranged. When the compatibility between the two collation methods and the attribute of the pattern to be collated is known in advance, designation can be done to execute collation first by using the more compatible method, and the collation determination result can quickly be obtained. Even when the collation pattern is a pattern that cannot be correctly collated by the method executed first, it can correctly be collated by the method to be executed next. Hence, the collation accuracy increases.

According to the present invention, the image of the collation pattern is inspected, and it is decided on the basis of the inspection result whether collation by the correlation method is to be executed first or collation by the feature point method is to be executed first. When the collation pattern has a small area or a high image quality, collation by the feature point method is executed first. In this way, collation by a collation method suitable for each collation pattern is preferentially executed. With this arrangement, both the collation accuracy and the collation speed can be increased.

According to the present invention, when no collation result indicating coincidence is obtained by first collation, the rotational shift amount (Δθ) between the two image data is obtained from the position of the correlation peak obtained in the collation process of the first collation. On the basis of the obtained rotational shift amount (Δθ), rotation shift correction is performed for one of the registration pattern and collation pattern. Then, the registration pattern and collation pattern are collated again by the amplitude suppression correlation method (second collation). When no collation result indicating coincidence is obtained by the second collation, the vertical and horizontal shift amounts (ΔX and ΔY) between the two image data are obtained from the position of the correlation peak obtained in the collation process of the second collation. On the basis of the obtained vertical and horizontal shift amounts (ΔX and ΔY) and the rotational shift amount (Δθ) obtained from the position of the correlation peak obtained in the collation process of the first collation, rotation shift correction and vertical/horizontal shift correction are performed for one of the registration pattern and collation pattern. Then, the registration pattern and collation pattern are collated by the feature point method (third collation). Even when the registration pattern and collation pattern have a rotational shift or vertical and horizontal shifts, collation can accurately be executed.

When the third collation is to be executed, the rotational shift and vertical and horizontal shifts have already been obtained in the collation processes of the first and second collations. The rotational shift and vertical and horizontal shifts can be corrected on the basis of these pieces of information. Hence, collation by the third collation can quickly be executed.

According to the present invention, for registration Fourier N-dimensional pattern data and collation Fourier N-dimensional pattern data which have undergone amplitude suppression processing, the signs of phases are added to the amplitudes, and only the amplitude components with signs are extracted. Then, the coordinate system is transformed into a polar coordinate system. With this arrangement, the influence of discontinuity of phases can be reduced. Hence, even when an error such as a positional shift exists between the registration pattern and the collation pattern, collation can accurately be executed.

According to the present invention, phase components are removed from registration Fourier N-dimensional pattern data and collation Fourier N-dimensional pattern data. Then, amplitude suppression processing is executed for registration Fourier N-dimensional pattern data and collation Fourier N-dimensional pattern data. The coordinate system of registration Fourier N-dimensional pattern data and collation Fourier N-dimensional pattern data that have undergone the amplitude suppression processing is transformed into a polar coordinate system. With this arrangement, the influence of a change in illuminance becomes small. Even when the illuminance changes between the registration time and the collation time, accurate collation can be executed. In addition, the performance in obtaining the correlation peak by the amplitude suppression correlation method using polar coordinate transformation can be improved.

What is claimed is:

1. A pattern collation apparatus for collating a registration pattern with a collation pattern, comprising:
first collation means for executing collation between the registration pattern and the collation pattern on the basis of a correlation value between the patterns;
second collation means for executing collation between the registration pattern and the collation pattern on the basis of a feature parameter defined in advance; and
collation determination means for determining that the registration pattern coincides with the collation pattern by using at least one of a collation result by said first collation means and a collation result by said second collation means.

2. An apparatus according to claim 1, wherein when at least one of the collation result by said first collation means and the collation result by said second collation means indicates coincidence between the registration pattern and the collation pattern, said collation determination means determines that the registration pattern coincides with the collation pattern.

3. An apparatus according to claim 1, wherein when the collation result by said first collation means indicates coincidence between the registration pattern and the collation pattern, said collation determination means determines that the registration pattern coincides with the collation pattern without executing collation by said second collation means.

4. An apparatus according to claim 1, wherein when the collation result by said second collation means indicates coincidence between the registration pattern and the collation pattern, said collation determination means determines that the registration pattern coincides with the collation pattern without executing collation by said first collation means.

5. An apparatus according to claim 1, wherein said apparatus further comprises execution order designation means for allowing designation of an execution order of collation by said first collation means and collation by said second collation means, and
when a collation result by collation means which is designated by said execution order designation means to be executed first indicates coincidence between the registration pattern and the collation pattern, said collation determination means determines that the registration pattern coincides with the collation pattern without executing collation by collation means which is designated to be executed later.

6. An apparatus according to claim 1, wherein said apparatus further comprises
image inspection means for inspecting an image of the collation pattern, and
execution order designation means for designating an execution order of collation by said first collation means and collation by said second collation means on the basis of an inspection result of the image of the collation pattern by said image inspection means, and
when a collation result by collation means which is designated by said execution order designation means to be executed first indicates coincidence between the registration pattern and the collation pattern, said collation determination means determines that the registration pattern coincides with the collation pattern without executing collation by collation means which is designated to be executed later.

7. A pattern collation apparatus comprising:
registration Fourier pattern data generation means for executing N-dimensional discrete Fourier transform for N-dimensional (N≧1) pattern data of a registration pattern to generate registration Fourier N-dimensional pattern data;
collation Fourier pattern data generation means for executing N-dimensional discrete Fourier transform for N-dimensional (N≧1) pattern data of a collation pattern to generate collation Fourier N-dimensional pattern data;
first amplitude suppression means for executing amplitude suppression processing for the registration Fourier N-dimensional pattern data;
second amplitude suppression means for executing amplitude suppression processing for the collation Fourier N-dimensional pattern data;
first polar coordinate system transformation means for obtaining a polar coordinate system from a coordinate system of the registration Fourier N-dimensional pattern data that has undergone the amplitude suppression processing by said first amplitude suppression means;
second polar coordinate system transformation means for obtaining a polar coordinate system from a coordinate system of the collation Fourier N-dimensional pattern data that has undergone the amplitude suppression processing by said second amplitude suppression means;
first collation means for collating, by an amplitude suppression correlation method, the registration Fourier N-dimensional pattern data of the polar coordinate system obtained by said first polar coordinate system transformation means with the collation Fourier N-dimensional pattern data of the polar coordinate system obtained by said second polar coordinate system transformation means;
rotational shift amount measurement means for obtaining a rotational shift amount between the pattern data from a position of a correlation peak obtained in a collation process by said first collation means;
rotational shift correction means for executing rotational shift correction for one of the registration pattern and the collation pattern on the basis of the rotational shift amount obtained by said rotational shift amount measurement means;
second collation means for, after rotational shift correction by said rotational shift correction means, collating the registration pattern with the collation pattern by the amplitude suppression correlation method;
vertical and horizontal shift amount measurement means for obtaining vertical and horizontal shift amounts between the pattern data from a position of a correlation peak obtained in a collation process by said second collation means;
rotational·vertical/horizontal shift correction means for executing rotational shift and vertical/horizontal shift correction for one of the registration pattern and the collation pattern on the basis of the rotational shift amount obtained by said rotational shift amount measurement means and the vertical and horizontal shift amounts obtained by said vertical and horizontal shift amount measurement means;
third collation means for, after the rotational shift and the vertical and horizontal shifts are corrected by said rotational·vertical/horizontal shift correction means, collating the registration pattern with the collation pattern on the basis of a feature parameter defined in advance; and
collation determination means for determining that the registration pattern coincides with the collation pattern when at least one of collation results by said first collation means, said second collation means, and said third collation means indicates coincidence between the registration pattern and the collation pattern.

8. An apparatus according to claim 7, wherein
said first polar coordinate system transformation means transforms the coordinate system of the registration Fourier N-dimensional pattern data that has undergone the amplitude suppression processing by said first amplitude suppression means into the polar coordinate system, and
said second polar coordinate system transformation means transforms the coordinate system of the collation Fourier N-dimensional pattern data that has undergone the amplitude suppression processing by said second amplitude suppression means into the polar coordinate system.

9. An apparatus according to claim 7, wherein
said first polar coordinate system transformation means adds a sign of a phase to the registration Fourier N-dimensional pattern data that has undergone the amplitude suppression processing by said first amplitude suppression means, extracts only an amplitude component with the sign, and then transforms the coordinate system of the registration Fourier N-dimensional pattern data into the polar coordinate system, and
said second polar coordinate system transformation means adds a sign of a phase to the collation Fourier N-dimensional pattern data that has undergone the amplitude suppression processing by said second amplitude suppression means, extracts only an amplitude component with the sign, and then transforms the coordinate system of the collation Fourier N-dimensional pattern data into the polar coordinate system.

10. An apparatus according to claim 7, wherein
said first amplitude suppression means removes a phase component of the registration Fourier N-dimensional pattern data and then executes the amplitude suppression processing for the registration Fourier N-dimensional pattern data, and
said second amplitude suppression means removes a phase component of the collation Fourier N-dimensional pattern data and then executes the amplitude suppression processing for the collation Fourier N-dimensional pattern data.
